(19) United States
(12) Patent Application Publication
(10) Pub. No.: US 2026/0046555 A1
(43) Pub. Date: Feb. 12, 2026

(54) ACOUSTIC OUTPUT DEVICES

(71) Applicant: SHENZHEN SHOKZ CO., LTD., Shenzhen (CN)

(72) Inventors: Jianing LIANG, Shenzhen (CN); Chaowu LI, Shenzhen (CN); Lei ZHANG, Shenzhen (CN); Xin QI, Shenzhen (CN)

(73) Assignee: SHENZHEN SHOKZ CO., LTD., Shenzhen (CN)

(21) Appl. No.: 19/364,061

(22) Filed: Oct. 21, 2025

Related U.S. Application Data
(63) Continuation of application No. PCT/CN2023/139237, filed on Dec. 15, 2023.

(51) Int. Cl. H04R 1/34; H04R 1/10; H04R 1/24

(52) U.S. Cl. CPC H04R 1/345; H04R 1/1008; H04R 1/105; H04R 1/1075; H04R 1/24

(57) ABSTRACT

The present disclosure provides an acoustic output device, comprising a housing and a support structure. The support structure is configured to place the housing near an ear canal of a user without blocking an ear canal opening. A low-frequency acoustic unit and a high-frequency acoustic unit are provided in the housing. The housing is provided with at least two sound guiding holes. A first sound guiding hole and a second sound guiding hole are acoustically coupled to two sides of a diaphragm of the low-frequency acoustic unit, respectively. One sound guiding hole of the at least two sound guiding holes is acoustically coupled to one side of a diaphragm of the high-frequency acoustic unit. In a wearing state of the acoustic output device, the sound guiding hole corresponding to the high-frequency acoustic unit is oriented toward the ear canal of the user. By providing the high-frequency acoustic unit and orienting its corresponding sound guiding hole toward the ear canal, the high-frequency sound volume reaching the ear canal of the user can be enhanced. This addresses the insufficient mid-to-high-frequency output of the acoustic output device, ensuring optimal acoustic performance across the entire frequency range.

### CROSS-REFERENCE TO RELATED APPLICATION

The present application is a continuation of International Application No. PCT/CN2023/139237, filed on Dec. 15, 2023, the entire content of which is hereby incorporated by reference.

### TECHNICAL FIELD

The present disclosure relates to the technical field of acoustics, and in particular, to acoustic output devices.

### BACKGROUND

With the development of acoustic output technology, acoustic output devices (e.g., earphones) have been widely used in daily life. The acoustic output devices may be used in conjunction with electronic devices such as mobile phones and computers to provide users with an auditory experience. Based on the wearing manners of users, acoustic output devices may be generally classified into an over-ear type acoustic output device, an on-ear type acoustic output device, and an in-ear type acoustic output device. Traditional in-ear or over-ear earphones cover or block the user's ear canal, which affects the user's listening experience in certain scenarios. For example, during activities such as running, cycling, or swimming, it may be difficult for the user to clearly hear ambient sounds, and prolonged wearing may also cause discomfort. Furthermore, the frequency response curve of current open-ear earphones exhibits significant attenuation in a mid-to-high frequency range (e.g., frequencies above 8 kHz), resulting in muffled mid-to-high frequency sounds and poor output performance.

Therefore, it is desirable to provide an acoustic output device with improved output performance.

### SUMMARY

The present disclosure provides an acoustic output device. The acoustic output device includes a low-frequency acoustic unit, a high-frequency acoustic unit, a housing configured to at least accommodate the low-frequency acoustic unit and the high-frequency acoustic unit, and a support structure configured to place the housing at a position near an ear canal without blocking an ear canal opening of the ear canal. At least two sound guiding holes are provided on the housing. A first sound guiding hole and a second sound guiding hole of the at least two sound guiding holes are acoustically coupled to two sides of a diaphragm of the low-frequency acoustic unit, respectively. The low-frequency acoustic unit radiates sound to an exterior of the housing through the first sound guiding hole and the second sound guiding hole. One sound guiding hole of the at least two sound guiding holes is acoustically coupled to one side of a diaphragm of the high-frequency acoustic unit. The high-frequency acoustic unit radiates sound to the exterior of the housing through the one sound guiding hole. In a wearing state of the acoustic output device, the one sound guiding hole corresponding to the high-frequency acoustic unit is oriented toward the ear canal of a user.

Additional features will be set forth in part in the description that follows. These features will be apparent to those skilled in the art upon reference to the following content and accompanying drawings, or may be learned through the production or operation of the embodiments. The features of the present disclosure may be realized and obtained through the practice or use of the aspects, methods, tools, and combinations of various aspects described in the following embodiments.

### BRIEF DESCRIPTION OF THE DRAWINGS

The present disclosure is further illustrated by way of exemplary embodiments, which will be described in detail with reference to the accompanying drawings. These embodiments are not limiting, and in these embodiments, the same reference numerals denote the same structures, wherein:

FIG. 1 is a schematic diagram of an exemplary auricle according to some embodiments of the present disclosure;

FIG. 2 is an exemplary block diagram of an acoustic output device according to some embodiments of the present disclosure;

FIG. 3 is an exemplary wearing schematic diagram of an acoustic output device according to some embodiments of the present disclosure;

FIG. 4 is a schematic diagram of an interior of a housing according to some embodiments of the present disclosure;

FIG. 5A is a schematic diagram of frequency response curves of an acoustic output device under different conditions according to some embodiments of the present disclosure;

FIG. 5B is an enlarged view of the high-frequency curves in FIG. 5A;

FIG. 6 is a schematic diagram of an external contour of a housing according to some embodiments of the present disclosure;

FIG. 7A to FIG. 7C are schematic diagrams showing positions of a first sound guiding hole and a third sound guiding hole according to some embodiments of the present disclosure;

FIG. 8 is a wearing schematic diagram showing a housing of an acoustic output device extending into a cavum concha according to some embodiments of the present disclosure;

FIG. 9 is a schematic diagram of an acoustic model formed by an acoustic output device according to some embodiments of the present disclosure;

FIG. 10 is a schematic diagram of frequency response curves of an acoustic output device corresponding to different placement positions of a high-frequency acoustic unit according to some embodiments of the present disclosure;

FIG. 11 is an exemplary wearing schematic diagram of an acoustic output device according to some other embodiments of the present disclosure;

FIG. 12 is a schematic diagram of an acoustic model formed by an acoustic output device according to yet some other embodiments of the present disclosure;

FIG. 13 is a schematic diagram showing a position of an acoustic output device relative to an auricle according to some embodiments of the present disclosure;

FIG. 14 is a schematic diagram showing a distribution of high-frequency sound waves when a high-frequency acoustic unit is arranged to protrude from a housing according to some embodiments of the present disclosure;

FIG. 15 is a schematic diagram showing a distribution of high-frequency sound waves when a high-frequency acoustic unit is embedded in a housing according to some embodiments of the present disclosure;

FIG. 16 is a schematic diagram showing a directivity of a high-frequency acoustic unit when the high-frequency acoustic unit is placed at different positions relative to a housing according to some embodiments of the present disclosure;

FIG. 17 is a schematic diagram of frequency response curves of a high-frequency acoustic unit when the high-frequency acoustic unit is placed at different positions relative to a housing according to some embodiments of the present disclosure;

FIG. 18A to FIG. 18D are schematic diagrams of a housing corresponding to different placement positions of a high-frequency acoustic unit according to some embodiments of the present disclosure;

FIG. 19A is a schematic diagram of frequency response curves of an acoustic output device corresponding to different placement positions of a high-frequency acoustic unit according to some embodiments of the present disclosure; and

FIG. 19B is an enlarged view of the mid-to-high frequency curves in FIG. 19A.

### DETAILED DESCRIPTION

To more clearly illustrate the technical solutions of the embodiments of the present disclosure, the accompanying drawings to be used in the description of the embodiments will be briefly described below. Obviously, the accompanying drawings in the following description are only some examples or embodiments of the present disclosure, and that the present disclosure may be applied to other similar scenarios in accordance with these drawings without creative labor for those of ordinary skill in the art. Unless obviously acquired from the context or the context illustrates otherwise, the same numeral in the drawings refers to the same structure or operation.

As indicated in the present disclosure and in the claims, the singular forms “a,” “an,” and “the” may be intended to include the plural forms as well, unless the context clearly indicates otherwise. In general, the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof. The term “based on” means “at least partially based on.” The term “an embodiment” or “one embodiment,” means “at least one embodiment”; the term “another embodiment” means “at least one further embodiment.”

In the description of the present disclosure, it should be understood that terms such as “front,” “rear,” “ear-hook,” and “rear-hook” indicating orientation or positional relationships are based on the orientation or positional relationships shown in the accompanying drawings. These terms are used solely to facilitate the description of the present disclosure and simplify the description, and do not indicate or imply that the referred device or component must have a specific orientation or be constructed and operated in a specific orientation. Thus, these terms should not be construed as limiting the present disclosure.

Furthermore, the terms “first” and “second” are used for descriptive purposes only and should not be construed as indicating or implying relative importance or implicitly specifying the quantity of the indicated technical features. Thus, features defined by “first” or “second” may explicitly or implicitly include at least one such feature. In the description of the present disclosure, the term “a plurality of” means at least two, such as two, three, etc., unless otherwise explicitly and specifically defined.

In the present disclosure, unless otherwise explicitly specified and defined, terms such as “mount,” “connect,” “link,” “fix,” etc., should be interpreted broadly. For example, a connection may be a fixed connection, a detachable connection, or an integral connection; it may be a mechanical connection, an electrical connection, or a direct connection, or it may be an indirect connection through an intermediate medium. It may also refer to the internal communication between two components or the interaction relationship between two components, unless otherwise explicitly defined. For those of ordinary skill in the art, the specific meanings of the above terms in the present disclosure can be understood based on the specific context.

Embodiments of the present disclosure provide an acoustic output device, which includes a housing and a support structure. The support structure is configured to position the housing near an ear canal of a user without blocking an ear canal opening, thereby keeping the user's ear canal open. This configuration allows the user to receive sounds from an external environment while using the acoustic output device, thereby enhancing the user experience. A low-frequency acoustic unit and a high-frequency acoustic unit are provided in the housing, and at least two sound guiding holes are provided on the housing. Two of the at least two sound guiding holes (e.g., a first sound guiding hole and a second sound guiding hole) are acoustically coupled to two sides of a diaphragm of the low-frequency acoustic unit, respectively. The low-frequency acoustic unit radiates sound to an exterior of the housing through the two sound guiding holes. One sound guiding hole of the at least two sound guiding holes is acoustically coupled to one side of a diaphragm of the high-frequency acoustic unit, and the high-frequency acoustic unit radiates sound to the exterior of the housing through the one sound guiding hole. In a wearing state of the acoustic output device, the sound guiding hole corresponding to the high-frequency acoustic unit is oriented toward the ear canal of the user. By providing the high-frequency acoustic unit and orienting the sound guiding hole acoustically coupled to the high-frequency acoustic unit toward the ear canal of the user, the volume of high-frequency sounds (e.g., above 8 kHz) in the ear canal of the user can be increased, compensating for the insufficient output of the acoustic output device in a mid-to-high frequency range (e.g., frequencies above 8 kHz). This ensures that the acoustic output device delivers optimal acoustic performance across the full frequency range.

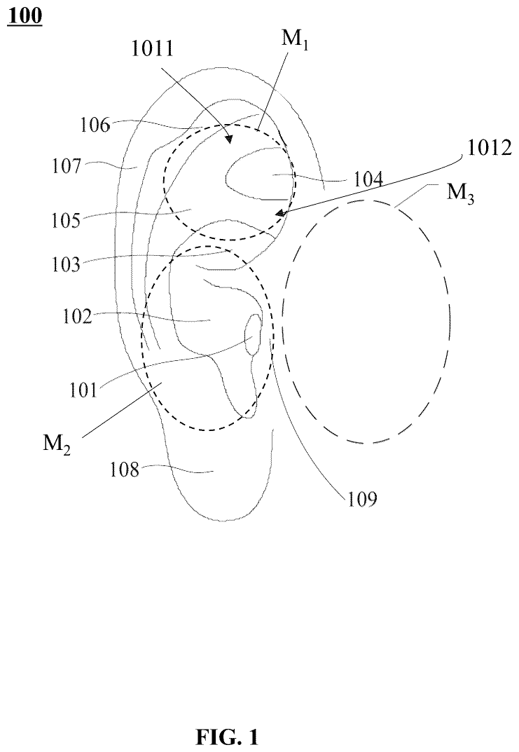

FIG. 1 is a schematic diagram of an exemplary auricle according to some embodiments of the present disclosure. Referring to FIG. 1, an auricle 100 may include an ear canal 101, a cavum concha 102, a cymba concha 103, a triangular fossa 104, an antihelix 105, a scaphoid fossa 106, a helix 107, an earlobe 108, and a crus of helix 109. For clarity, in the embodiments of the present disclosure, a superior antihelix crus 1011, an inferior antihelix crus 1012, and the antihelix 105 are collectively referred to as an antihelix region. In some embodiments, one or more parts of the auricle 100 may be utilized to achieve wearing and stability of an acoustic output device. In some embodiments, parts of the auricle 100, such as the ear canal 101, the cavum concha 102, the cymba concha 103, and the triangular fossa 104, possess certain depth and volume in three-dimensional space, which can be utilized to meet wearing requirements of the acoustic output device. For example, an acoustic output device (e.g., an in-ear earphone) may be worn inside the ear canal 101. In some embodiments, other parts of the auricle 100 besides the ear canal 101 may be used to wear the acoustic output device. For example, the cymba concha 103, the triangular fossa 104, the antihelix 105, the scaphoid fossa 106, the helix 107, or any combination thereof may be utilized to wear the acoustic output device. In some embodiments, to improve wearing comfort and reliability of the acoustic output device, an earlobe 108 or other parts of the user may also be utilized. By leveraging parts of the auricle 100 other than the ear canal 101 for wearing and sound transmission, the ear canal 101 of the user can be “liberated,” reducing the impact of the acoustic output device on the user's ear health. When the user wears the acoustic output device on a road, the acoustic output device does not block the ear canal 101, allowing the user to receive both sound from the acoustic output device and environmental sounds (e.g., horns, bicycle bells, surrounding voices, traffic commands, etc.), thereby reducing the likelihood of traffic accidents. For example, when the user wears the acoustic output device, the entire acoustic output device or a portion of the acoustic output device may be located on a front side (e.g., a region M₃ enclosed by dashed lines in FIG. 1) of the crus of helix 109. As another example, when the user wears the acoustic output device, the entire acoustic output device or a portion (e.g., region(s) where one or more of the crus of helix 109, the cymba concha 103, the triangular fossa 104, the antihelix 105, the scaphoid fossa 106, the helix 107, etc., are located) of the acoustic output device may contact an upper part of the ear canal 101. As yet another example, when the user wears the acoustic output device, the entire acoustic output device or a portion of the acoustic output device may be located within one or more parts (e.g., the cavum concha 102, cymba concha 103, triangular fossa 104, etc.) of the auricle, such as a region M₁ enclosed by dashed lines in FIG. 1, which includes at least the cymba concha 103 and the triangular fossa 104, and a region M₂, which includes at least the cavum concha 102.

Different users may have individual differences, resulting in dimensional differences such as different shapes and sizes of the auricle 100. To facilitate description and for clarity of understanding, unless otherwise specified, the present disclosure mainly uses an auricle model with a “standard” shape and size as a reference to further describe wearing manners of the acoustic output device on the auricle model in different embodiments. By way of example, a simulator (e.g., GRAS 45BC KEMAR) containing a head and its (left and right) ears, manufactured based on standards such as ANSI: S3.36, S3.25, and IEC: 60318-7, may be used as a reference for wearing the acoustic output device, thereby presenting a scenario of how most users normally wear acoustic output devices. In the present disclosure, descriptions such as “user wearing,” “worn by the user,” “in a wearing state,” and “under worn conditions” refer to the acoustic output device described herein being worn on the auricle 100 of the aforementioned simulator. Naturally, considering individual differences among users, the structure, shape, size, thickness, etc., of one or more parts of the auricle 100 may be differentially designed based on auricles 100 of varying shapes and dimensions. Such differential designs may manifest as feature parameters of one or more components (e.g., the housing, support structure, etc., described below) of the acoustic output device, potentially having values within different ranges to adapt to different auricles 100. Additionally, it should be noted that the “non-wearing state” is not limited solely to a state where the earphone is not worn on the auricle 100 of the user, but also includes the state where the earphone is not deformed by external forces; the “wearing state” is not limited solely to a state where the earphone is worn on the auricle 100 of the user. If the support structure and the housing are positioned such that the states of all components are identical to their states when the earphone is worn (e.g., maintaining corresponding distances between structures), this can also be considered a wearing state.

It should be noted that in fields such as medicine and anatomy, three basic planes of the human body, including a sagittal plane, a coronal plane, and a horizontal plane, and three basic axes, including a sagittal axis, a coronal axis, and a vertical axis, may be defined. The sagittal plane refers to a plane perpendicular to the ground and runs along a front-rear direction of the human body, which divides the human body into a left part and a right part. The coronal plane refers to a plane perpendicular to the ground and runs along a left-right direction of the human body, which divides the human body into a front part and a rear part. The horizontal plane refers to a plane parallel to the ground and runs along an up-down direction of the human body, which divides the human body into an upper part and a lower part. Correspondingly, the sagittal axis is an axis along the front-rear direction of the human body and perpendicular to the coronal plane, the coronal axis is an axis along the left-right direction of the human body and perpendicular to the sagittal plane, and the vertical axis is an axis along the up-down direction of the human body and perpendicular to the horizontal plane. Furthermore, the term “front side of the auricle” in the present disclosure is a concept relative to the term “rear side of the auricle.” The front side of the auricle refers to a side of the auricle away from the head, while the rear side of the auricle refers to a side of the auricle facing towards the head, both being defined relative to the auricle of the user. Observing the auricle of the aforementioned simulator along the direction of the coronal axis yields the schematic diagram of a front contour of the auricle shown in FIG. 1.

The description of the aforementioned auricle 100 is for illustrative purposes only and is not intended to limit the scope of the present disclosure. Those of ordinary skill in the art can make various changes and modifications based on the description herein. For example, part of the structure of the acoustic output device may block a portion of the ear canal 101 or the entire ear canal 101. Such changes and modifications still fall within the protection scope of the present disclosure.

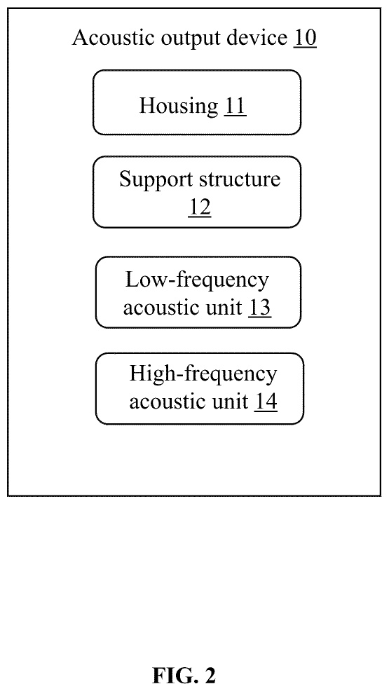

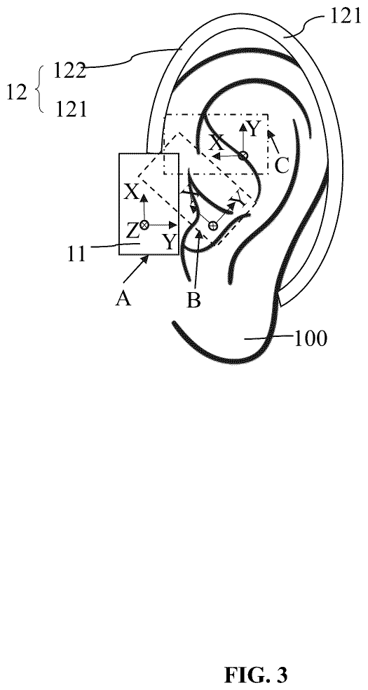

FIG. 2 is an exemplary block diagram of an acoustic output device according to some embodiments of the present disclosure. FIG. 3 is an exemplary wearing schematic diagram of an acoustic output device according to some embodiments of the present disclosure.

In some embodiments, an acoustic output device 10 may include a pair of eyeglasses, a smart bracelet, an earphone, a hearing aid, a smart helmet, a smartwatch, smart clothing, a smart backpack, a smart accessory, etc., or any combination thereof. For example, the acoustic output device 10 may be functional nearsighted glasses, presbyopia glasses, cycling glasses, or sunglasses. As another example, the acoustic output device 10 may be smart glasses, such as audio glasses with earphone functionality. The acoustic output device 10 may also be a head-mounted device such as a helmet, an Augmented Reality (AR) device, or a Virtual Reality (VR) device. In some embodiments, the AR device or the VR device may include a VR helmet, VR glasses, an AR helmet, AR glasses, etc., or any combination thereof. For example, the VR device and/or the AR device may include Google Glass, Oculus Rift, Hololens, Gear VR, etc.

Referring to FIG. 2 and FIG. 3, in some embodiments, the acoustic output device 10 may include a housing 11, a support structure 12, a low-frequency acoustic unit 13, and a high-frequency acoustic unit 14. The support structure 12 is connected to the housing 11, and both the low-frequency acoustic unit 13 and the high-frequency acoustic unit 14 are arranged within the housing 11. The low-frequency acoustic unit 13 and the high-frequency acoustic unit 14 work in coordination to achieve an acoustic output of the acoustic output device 10.

The housing 11 is connected to the support structure 12 and is configured to accommodate the low-frequency acoustic unit 13 and the high-frequency acoustic unit 14. In some embodiments, the housing 11 may be an enclosed hollow structure, and the low-frequency acoustic unit 13 and the high-frequency acoustic unit 14 are located inside the housing 11. In some embodiments, the acoustic output device 10 may be integrated with products such as glasses, an over-ear headphone, a head-mounted display, or an AR/VR helmet. In such cases, the housing 11 may be fixed near the auricle 100 of the user by suspension or clamping. In some alternative embodiments, the housing 11 may be provided with a suspension structure (e.g., a hook). For example, the hook may be shaped to match the contour of the auricle, allowing the acoustic output device 10 to be independently worn on the auricle 100 of the user via the hook.

In some embodiments, the housing 11 may be a shell structure with a shape adapted to the auricle 100. For example, the shape of the housing 11 may be circular, oval, racetrack-shaped, polygonal (regular or irregular), U-shaped, V-shaped, semicircular, or other regular or irregular shapes, enabling the housing 11 to be directly hooked onto the auricle 100 of the user. In some embodiments, the housing 11 may further include a fixing structure. The fixing structure may include an ear hook, an elastic band, etc., to ensure that the acoustic output device 10 can be securely worn on the user and prevent the acoustic output device 10 from falling off during use.

In some embodiments, the housing 11 may have a long-axis direction X, a short-axis direction Y, and a thickness direction Z that are mutually orthogonal with each other. The long-axis direction X may be defined as a direction in which the housing 11 has a greater dimension in the shape of its two-dimensional projection (e.g., a projection of the housing 11 on a plane of its inner side surface, i.e., a side facing the auricle 100, or on the sagittal plane). For example, when the shape of the projection is rectangular or approximately rectangular, the long-axis direction X is a lengthwise direction of the rectangle or approximate rectangle. For ease of description, the present disclosure will describe the projection of the housing on the sagittal plane. The short-axis direction Y may be defined as a direction perpendicular to the long-axis direction X in the shape of the projection of the housing 11 on the sagittal plane (e.g., when the shape of the projection is rectangular or approximately rectangular, the short-axis direction is a width direction of the rectangle or approximate rectangle). The thickness direction Z may be defined as a direction perpendicular to the sagittal plane, for example, a direction aligned with the direction of the coronal axis, i.e., the left-right direction of the body.

With reference to FIG. 1, FIG. 2, and FIG. 3, in some embodiments, when the user wears the acoustic output device 10, at least a portion of the housing 11 may be located in a region M₃ on a front side of a tragus of the auricle 100 of the user as shown in FIG. 1, or in regions M₁ and M₂ on an anterolateral surface of the auricle. It should be noted that the term “anterolateral surface of the auricle” in the embodiments of the present disclosure refers to a side of the auricle away from the head along the direction of the coronal axis. Correspondingly, the term “posteromedial surface of the auricle” refers to a side of the auricle facing toward the head along the direction of the coronal axis. In some embodiments, the housing 11 may be provided with at least two sound guiding holes for transmitting sound. In some embodiments, two of the at least two sound guiding holes are acoustically coupled to two sides of a diaphragm of the low-frequency acoustic unit 13, respectively. The low-frequency acoustic unit 13 radiates sound to an exterior of the housing 11 through the two sound guiding holes. One sound guiding hole of the at least two sound guiding holes is acoustically coupled to one side of a diaphragm of the high-frequency acoustic unit 14. The high-frequency acoustic unit 14 radiates sound to the exterior of the housing 11 through the one sound guiding hole, and in a wearing state of the acoustic output device, the sound guiding hole corresponding to the high-frequency acoustic unit 14 is oriented toward the ear canal of the user.

In some embodiments, in the wearing state, the housing 11 may be located on a side of the auricle of the user facing a facial region along a direction of the sagittal axis, i.e., at a position represented by the solid-line box A in FIG. 3. Under this configuration, the housing 11 is positioned in the facial region M₃ on the front side of the auricle. The long axis of the housing 11 may be in a vertical or approximately vertical state, the projection of the short-axis direction Y on the sagittal plane aligns with the direction of the sagittal axis, the projection of the long-axis direction X on the sagittal plane aligns with the direction of the vertical axis, and the thickness direction Z remains perpendicular to the sagittal plane. In some embodiments, when the housing 11 is in an inclined state during wearing (e.g., the position shown by dashed-line box B in FIG. 3), the long-axis direction X and short-axis direction Y may still be parallel or approximately parallel to the sagittal plane. The long-axis direction X may form an angle with the direction of the sagittal axis, i.e., the long-axis direction X is inclined, and the short-axis direction Y may form an angle with the direction of the vertical axis, i.e., the short-axis direction Y is also inclined. The thickness direction Z remains perpendicular to the sagittal plane. Under this configuration, the acoustic output device 10 is located in the region M2. Since the cavum concha 102 has a certain volume and depth, a gap exists between an inner side surface of the acoustic output device 10 and the cavum concha. The ear canal may communicate with the external environment through a leakage structure between the inner side surface and the cavum concha, thereby freeing the user's ears. Simultaneously, the housing 11 of the acoustic output device 10 and the cavum concha may cooperatively form an auxiliary cavity connected to the ear canal. In some embodiments, at least one sound guiding hole may be at least partially located within the auxiliary cavity. Sound emitted from the sound guiding hole may be constrained by the auxiliary cavity, meaning that the auxiliary cavity can focus the sound, allowing more sound to propagate into the ear canal. This enhances the volume and quality of sound heard by the user in a near field, thereby improving the acoustic performance of the acoustic output device 10. In some embodiments, the housing 11 may also be in a horizontal or approximately horizontal state during wearing, as shown by the position of dashed-line box C in FIG. 3. In the horizontal or approximately horizontal state, at least a portion of the housing 11 is located at the antihelix 105. The long-axis direction X of the housing 11 may align or approximately align with the direction of the sagittal axis (both pointing in the front-rear direction of the human body), and the short-axis direction Y may align or approximately align with the direction of the vertical axis (both pointing in the up-down direction of the human body). The thickness direction Z remains perpendicular to the sagittal plane. This configuration avoids obstruction of the ear canal by the housing 11, thereby freeing the user's ears and increasing a contact area between the housing 11 and the auricle 100, thus improving the wearing comfort of the acoustic output device 10. It should be noted that the “approximately horizontal state” of the housing 11 in the wearing state shown by dashed-line box C may refer to an angle between the long-axis direction X of the housing 11 and the sagittal axis being within a specific range (e.g., not exceeding 20°). Furthermore, the wearing position of the housing 11 is not limited to positions A, B, C, etc., shown in FIG. 3, as long as the wearing position is located within the region M₃, the region M₁, or the region M₂ shown in FIG. 1. For example, the entire housing 11 or a portion of its structure may be located within the region M₃ enclosed by dashed lines in FIG. 1. As another example, the entire acoustic output device or a portion of the acoustic output device may contact an upper part of the ear canal 101 (e.g., region(s) where one or more of the crus of helix 109, the cymba concha 103, the triangular fossa 104, the antihelix 105, the scaphoid fossa 106, the helix 107, etc., are located). As yet another example, when the user wears the acoustic output device, the entire acoustic output device or a portion of the acoustic output device may be located within a cavity formed by one or more parts (e.g., the cavum concha 102, cymba concha 103, triangular fossa 104, etc.) of the auricle, such as the region M₁ enclosed by dashed lines in FIG. 1, which includes at least the cymba concha 103 and the triangular fossa 104, and the region M₂, which includes at least the cavum concha 102.

In some embodiments, the support structure 12 is configured to place the housing 11 at a position near the ear canal of the user without blocking the ear canal opening, thereby maintaining the auricle 100 in an open state. This allows the user to simultaneously hear sound output from the acoustic output device 10 and sounds from the external environment. For example, the acoustic output device 10 may be arranged to partially or fully surround a periphery of the auricle 100 of the user and transmit sound via air conduction or bone conduction. In some embodiments, the support structure 12 may vary depending on the type of the acoustic output device 10. By way of example, when the acoustic output device 10 is an earphone, the support structure 12 may be an ear hook; when the acoustic output device 10 is eyeglasses, the support structure 12 may be a temple arm; when the acoustic output device 10 is a wristband, the support structure 12 may be a band; and when the acoustic output device 10 is a head-mounted device, the support structure 12 may be a helmet, etc.

In some embodiments, taking the acoustic output device 10 being an open-ear earphone as an example, the corresponding support structure 12 may be an ear hook. The ear hook may include a first portion 121 and a second portion 122 connected sequentially. In the wearing state, the first portion 121 of the support structure 12 is hooked between the user's auricle and the head, and the second portion 122 extends toward the side of the auricle away from the head and connects to the housing 11, thereby positioning the housing 11 near the ear canal without blocking the ear canal.

In some embodiments, to enhance the stability of the acoustic output device 10 in the wearing state, the acoustic output device 10 may employ any one or a combination of the following approaches. First, at least a portion of the support structure 12 is designed as a contoured structure that conforms to at least one of the rear side of the auricle 100 and the head, thereby increasing the contact area between the support structure 12 and the auricle 100 and/or the head, and thus increasing the resistance of the acoustic output device 10 to fall off from the auricle 100. Second, at least a portion of the support structure 12 may be designed as an elastic structure, allowing it to undergo a certain degree of deformation in the wearing state, thereby increasing the normal pressure exerted by the support structure 12 on the auricle 100 and/or the head, and thus enhancing the resistance of the acoustic output device 10 to fall off from the auricle 100. Third, at least a portion of the support structure 12 may be configured to lean against the head in the wearing state, generating a reaction force that presses against the auricle 100, thereby causing the housing 11 to press against the anterolateral surface of the auricle 100 (e.g., regions M₁ and M₂ shown in FIG. 1), and thus increasing the resistance of the acoustic output device 10 to fall off from the auricle 100. Fourth, the housing 11 and the support structure 12 may be designed to clamp the region of the antihelix 105, the region of the cavum concha, etc., from an anterolateral surface and a posteromedial surface of the auricle 100 in the wearing state, thereby increasing the resistance of the acoustic output device 10 to falling off from the auricle 100. Fifth, the housing 11 or an auxiliary structure connected thereto may be designed to at least partially extend into cavities such as the cavum concha 102, the cymba concha 103, the triangular fossa 104, and the scaphoid fossa 106, thereby increasing the resistance of the acoustic output device 10 to falling off from the auricle 100.

In some embodiments, the support structure 12 may have an arcuate structure adapted to a junction between the user's head and auricle 100, enabling the support structure 12 to be hooked between the user's auricle 100 and head. By way of example, the first portion 121 of the support structure 12 connects the second portion 122 to the housing 11 such that when the acoustic output device 10 is in the non-wearing state (i.e., the natural state), the acoustic output device 10 has a curved shape in three-dimensional space. In other words, in three-dimensional space, the second portion 122, the first portion 121, and the housing 11 are not coplanar. Through this configuration, when the acoustic output device 10 is in the wearing state, the second portion 122 is hooked between the rear side of the user's auricle 100 and head, and the housing 11 contacts the front side (e.g., region M₃ in FIG. 1) of the auricle 100 of the user or the auricle 100 itself (e.g., regions M₁ and M₂ in FIG. 1). Thus, the housing 11 and the second portion 122 can cooperate to clamp the auricle 100. Specifically, the first portion 121 may extend outward from the head, working in conjunction with the second portion 122 to provide a clamping force that presses the housing 11 against the front side of the auricle 100 or the auricle itself. Under the clamping force, the housing 11 may press against regions such as the front side of the auricle 100 or the cavum concha 102, the cymba concha 103, the triangular fossa 104, the antihelix 105, etc., ensuring that the acoustic output device 10 does not block the ear canal 101 of the auricle 100 in the wearing state.

In some embodiments, the low-frequency acoustic unit 13 and the high-frequency acoustic unit 14 may be configured to convert signals containing sound information into sound signals. In some embodiments, the sound signals may include bone-conducted sound waves or air-conducted sound waves. For example, the low-frequency acoustic unit 13 and the high-frequency acoustic unit 14 may, in response to receiving signals containing sound information, generate mechanical vibrations to output sound waves (i.e., sound signals). In some embodiments, the low-frequency acoustic unit 13 refers to an acoustic transducer with superior acoustic output performance in a low-frequency range, enabling the acoustic output device 10 to have good low-frequency output performance. The high-frequency acoustic unit 14 refers to an acoustic transducer with superior acoustic output performance in a high-frequency range, enhancing the high-frequency output performance of the acoustic output device 10. The low-frequency range refers to a frequency range with frequencies below 8 kHz, and the high-frequency range refers to a frequency range with frequencies above 8 kHz. In some embodiments, the definitions of the low-frequency and high-frequency ranges may vary based on practical circumstances. For example, the low-frequency range may also refer to a frequency range with frequencies not exceeding 1 kHz, such as 1 Hz-1 kHz or 100 Hz-800 Hz; the high-frequency range may also refer to a frequency range with frequencies not less than 5 kHz, such as 5 kHz-10 KHz or 8 kHz-16 KHz.

In some embodiments, based on their working principles, types of the low-frequency acoustic unit 13 and the high-frequency acoustic unit 14 may include, but are not limited to, a moving coil transducer, a moving iron transducer, a flat plate transducer, a piezoelectric transducer, etc. Moving coil transducers offer high transduction efficiency, high sensitivity, and overall good sound quality, but their output performance in the high-frequency range is relatively poor. Moving iron transducers have high sensitivity, but their frequency response curves have a narrow flat range, and they feature intricate structures, high cost, and an elongated form factor, making design challenging. Piezoelectric transducers provide high transduction efficiency and high sensitivity, but they require high voltage to drive the piezoelectric element, and their frequency response curves are uneven in the high-frequency range, with significant peaks and valleys in vibration modes. Flat plate transducers exhibit relatively uniform force distribution across the diaphragm, effectively avoiding segmentation vibration, thereby minimizing sound distortion and delivering superior output performance in the high-frequency range.

Based on the foregoing analysis, in some embodiments, the low-frequency acoustic unit 13 may employ a moving coil transducer to ensure superior acoustic output in the low-frequency range. In some embodiments, the high-frequency acoustic unit 14 may employ a flat plate transducer to ensure superior acoustic output in the high-frequency range.

In some embodiments, a minimum resonant frequency corresponding to the high-frequency acoustic unit 14 is not less than 5 kHz, and a minimum resonant frequency corresponding to the low-frequency acoustic unit 13 is not higher than 1 kHz. Through this configuration, the low-frequency acoustic unit 13 can achieve substantial output in a mid-to-low frequency range (e.g., 1 kHz-8 kHz), and the high-frequency acoustic unit 14 can achieve substantial output in the high-frequency range (e.g., a frequency range with frequencies above 8 kHz). This ensures that the acoustic output device 10 delivers excellent acoustic performance across the full frequency range (e.g., a frequency range with frequencies above 1 kHz).

In some embodiments, to enable the acoustic output device 10 to achieve high acoustic output performance across a broad frequency range, a difference between the minimum resonant frequency of the high-frequency acoustic unit 14 and the minimum resonant frequency of the low-frequency acoustic unit 13 may be not less than 4 kHz. Alternatively, a ratio of the minimum resonant frequency of the high-frequency acoustic unit 14 to the minimum resonant frequency of the low-frequency acoustic unit 13 may be not less than 5. In some embodiments, to further enhance the acoustic output performance of the acoustic output device 10 in the mid-to-low frequency range, the minimum resonant frequency of the low-frequency acoustic unit 13 may be set relatively low. The difference between the minimum resonant frequency of the high-frequency acoustic unit 14 and the minimum resonant frequency of the low-frequency acoustic unit 13 may be not less than 6 kHz, or the ratio of the minimum resonant frequency of the high-frequency acoustic unit 14 to the minimum resonant frequency of the low-frequency acoustic unit 13 may be not less than 10. In some embodiments, to further improve the acoustic output performance of the acoustic output device 10 in the high-frequency range, the minimum resonant frequency of the high-frequency acoustic unit 14 may be set relatively high. The difference between the minimum resonant frequency of the high-frequency acoustic unit 14 and the minimum resonant frequency of the low-frequency acoustic unit 13 may be not less than 8 kHz, or the ratio of the minimum resonant frequency of the high-frequency acoustic unit 14 to the minimum resonant frequency of the low-frequency acoustic unit 13 may be not less than 20.

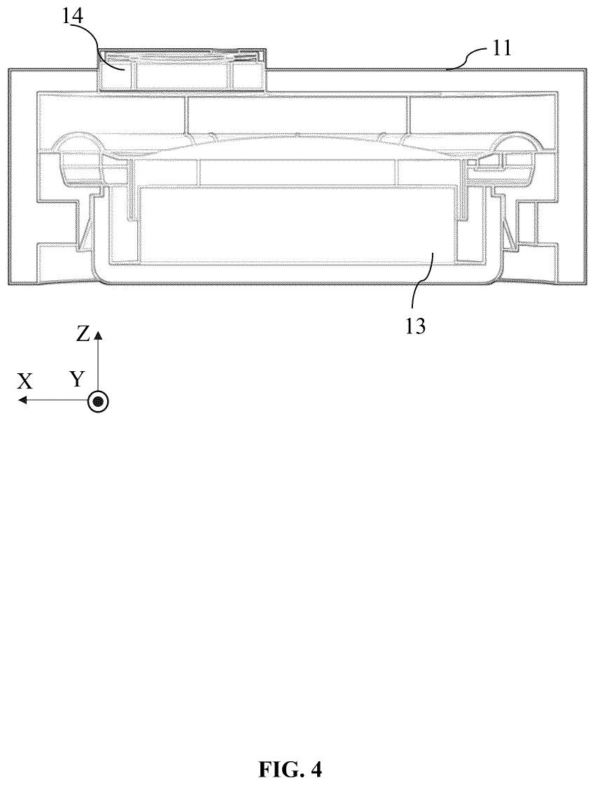

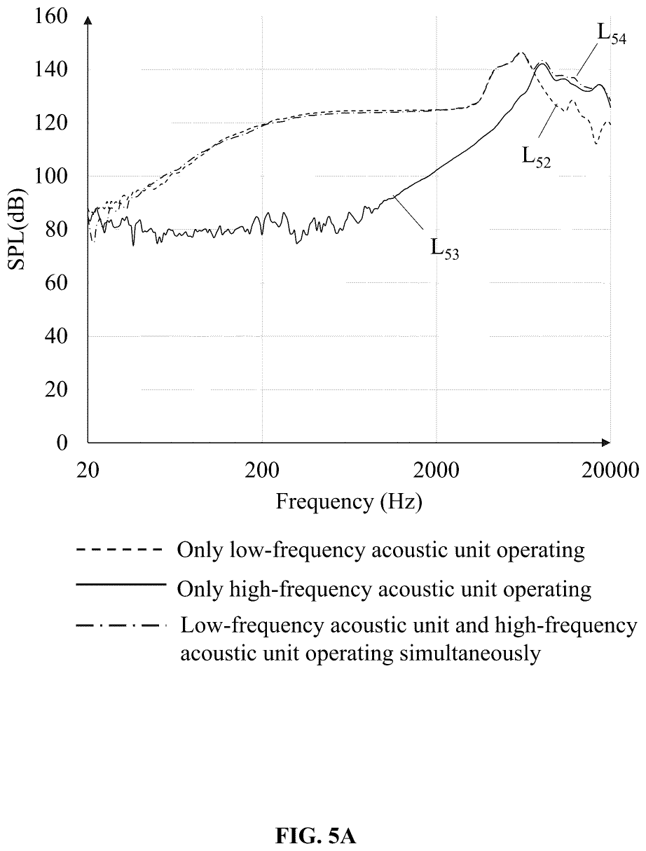

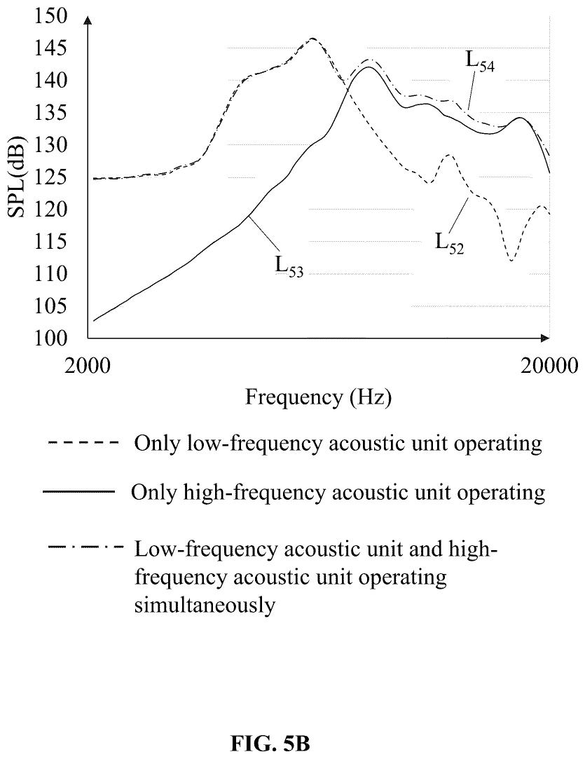

FIG. 4 is a schematic diagram of an interior of a housing according to some embodiments of the present disclosure. FIG. 5A is a schematic diagram of frequency response curves of an acoustic output device under different conditions according to some embodiments of the present disclosure. FIG. 5B is an enlarged view of the high-frequency curves in FIG. 5A. As shown in FIG. 5A and FIG. 5B, curve L₅₂ represents a frequency response curve of the acoustic output device 10 when only the low-frequency acoustic unit 13 is operating. Curve L₅₃ represents a frequency response curve of the acoustic output device 10 when only the high-frequency acoustic unit 14 is operating. Curve L₅₄ represents a frequency response curve of the acoustic output device 10 when both the low-frequency acoustic unit 13 and the high-frequency acoustic unit 14 are operating simultaneously. In some embodiments, as shown in FIG. 4, the low-frequency acoustic unit 13 may be disposed inside the housing 11, and the high-frequency acoustic unit 14 may be disposed inside the housing 11 but protrudes from a surface of the housing 11. The low-frequency acoustic unit 13 is a moving coil transducer; the high-frequency acoustic unit 14 is a flat plate transducer with a resonant frequency of 8 kHz. Voltages of input signals of the low-frequency acoustic unit 13 and the high-frequency acoustic unit 14 are both 0.5V, and phases of the input signals are the same. In some embodiments, the frequency response curves in FIG. 5A and FIG. 5B may be measured by a microphone. The microphone may be provided at a position 4 mm away from a corresponding sound guiding hole near the user's ear canal in the wearing state, oriented in a direction from the sound guiding hole towards the user's ear in the wearing state. When both the low-frequency acoustic unit 13 and the high-frequency acoustic unit 14 are operating simultaneously, the position of the microphone corresponding the sound guiding hole may be located at a midpoint between (e.g., a midpoint of a line connecting centers of) one of the two sound guiding holes corresponding to the low-frequency acoustic unit 13 that is closer to the user's ear canal in the wearing state and the sound guiding hole corresponding to the high-frequency acoustic unit 14. If the sound guiding hole corresponding to the high-frequency acoustic unit 14 completely overlaps with one of the two sound guiding holes corresponding to the low-frequency acoustic unit 13 that is closer to the user's ear canal in the wearing state, the microphone is positioned at a center of the larger one of the two overlapping sound guiding holes.

As shown in FIG. 5A and FIG. 5B, in the low-frequency range (e.g., below 800 Hz), curves L₅₂ and L₅₄ substantially overlap, indicating that the sound output of the acoustic output device 10 in the low-frequency range (e.g., below 800 Hz) is primarily produced by the low-frequency acoustic unit 13, and the presence of the high-frequency acoustic unit 14 has a negligible impact on the low-frequency output of the low-frequency acoustic unit 13. Curve L₅₂ shows a sharp attenuation starting at 7 kHz, indicating that the low-frequency acoustic unit 13 has poor output performance in the high-frequency range (e.g., above 8 kHz). Curve L₅₃ shows low output at low frequencies, a steady increase in output after 1.2 kHz, and remains at a high level with minimal attenuation after 7 kHz, indicating that the high-frequency acoustic unit 14 has good output performance in the high-frequency range (e.g., above 8 kHz). Curve L₅₄ may be regarded as a superimposed and fitted result of curves L₅₂ and L₅₃. Curve L₅₃ compensates for the attenuation segment of curve L₅₂ (e.g., above 7 kHz). Curve L₅₄ basically overlaps with curve L₅₂ before 7 kHz and essentially aligns with curve L₅₃ after 7 kHz. This demonstrates that adding the high-frequency acoustic unit 14 to the acoustic output device 10 ensures the low-frequency output performance while stably increasing the output sound pressure level in the high-frequency range (e.g., above 8 kHz), thereby enabling the acoustic output device 10 to achieve excellent output performance across the full frequency range. Furthermore, comparing curve L₅₄ with curve L₅₂ reveals that in the frequency range above 8 kHz, curve L₅₄ is 10 dB to 15 dB higher than curve L₅₂. This indicates that the inclusion of the high-frequency acoustic unit 14 can increase the output sound pressure level of the acoustic output device 10 in the high-frequency range (e.g., above 8 kHz) by 10 dB to 15 dB, representing a very significant enhancement in high-frequency performance.

In some embodiments, the housing 11 is provided with at least two sound guiding holes. Two of the at least two sound guiding holes (e.g., a first sound guiding hole 111 and a second sound guiding hole 112) are acoustically coupled to two sides of the diaphragm of the low-frequency acoustic unit 13, respectively. The low-frequency acoustic unit 13 radiates sound to the exterior of the housing 11 through the two sound guiding holes (e.g., the first sound guiding hole 111 and the second sound guiding hole 112). When the low-frequency acoustic unit 13 outputs sound waves, a sound wave (referred to as a first sound wave) from one side of the diaphragm may be emitted through one of the two sound guiding holes, and a sound wave (referred to as a second sound wave) from the other side of the diaphragm may be emitted through the other one of the two sound guiding holes. In some embodiments, the two sound guiding holes may emit two sets of sound waves with a phase difference (e.g., opposite phases), forming a dipole. The dipole may cause destructive interference at a point in space (e.g., in the far field of the acoustic output device 10), thereby effectively mitigating the issue of sound leakage in the far field within a mid-to-low frequency range (e.g., 100 Hz-800 Hz) of the acoustic output device 10.

In some embodiments, one sound guiding hole of the at least two sound guiding holes may be acoustically coupled to one side of the diaphragm of the high-frequency acoustic unit 14. The high-frequency acoustic unit 14 radiates sound to the exterior of the housing 11 through the one sound guiding hole. In the wearing state, the sound guiding hole corresponding to the high-frequency acoustic unit 14 faces the user's ear canal. The high-frequency acoustic unit 14 outputs a sound wave (referred to as a third sound wave) to the exterior of the housing 11 through only one sound guiding hole, forming a monopole. In some embodiments, within a mid-to-high frequency range (e.g., 800 Hz-10 kHz), the design of the monopole provides the high-frequency acoustic unit 14 with good directivity. Combined with the corresponding sound guiding hole that faces the user's ear canal, this configuration enhances the listening effect of the third sound wave output by the high-frequency acoustic unit 14 at the user's ear, allowing the ear canal opening to receive a higher sound volume and providing the user with a clear auditory experience. Through the arrangement of the high-frequency acoustic unit 14 and the corresponding sound guiding hole, the output sound pressure level of the acoustic output device 10 in the high-frequency range (e.g., 8 kHz-16 kHz) can be improved, ensuring the acoustic output performance of the acoustic output device 10 in the full frequency range.

In some embodiments, the sound guiding hole corresponding to the high-frequency acoustic unit 14 may be a third sound guiding hole (e.g., a third sound guiding hole 113) different from the two sound guiding holes (e.g., the first sound guiding hole 111 and the second sound guiding hole 112) corresponding to the low-frequency acoustic unit 13. That is to say, the third sound guiding hole (e.g., the third sound guiding hole 113) does not overlap with the aforementioned two sound guiding holes (e.g., the first sound guiding hole 111 and the second sound guiding hole 112). This arrangement allows for flexible design positioning of the third sound guiding hole (e.g., the third sound guiding hole 113), enhances the installation flexibility of the high-frequency acoustic unit 14, and ensures that the third sound guiding hole corresponding to the high-frequency acoustic unit 14 can be closer to the user's ear canal in the wearing state, thereby guaranteeing high-frequency output performance. In some embodiments, the sound guiding hole corresponding to the high-frequency acoustic unit 14 may also be one of the two sound guiding holes (e.g., the first sound guiding hole 111 and the second sound guiding hole 112) corresponding to the low-frequency acoustic unit 13. That is to say, the sound guiding hole corresponding to the high-frequency acoustic unit 14 may partially or fully overlap with one of the two sound guiding holes (e.g., the first sound guiding hole 111 and the second sound guiding hole 112) corresponding to the low-frequency acoustic unit 13, thereby simplifying the structural design and ensuring output consistency between the high-frequency acoustic unit 14 and the low-frequency acoustic unit 13. In some embodiments, when the sound guiding hole corresponding to the high-frequency acoustic unit 14 is a third sound guiding hole (e.g., the third sound guiding hole 113) different from the two sound guiding holes (e.g., the first sound guiding hole 111 and the second sound guiding hole 112) corresponding to the low-frequency acoustic unit 13, the third sound guiding hole may not overlap (i.e., have no overlapping portion) or may partially overlap with one of the two sound guiding holes (e.g., the first sound guiding hole 111 and the second sound guiding hole 112) corresponding to the low-frequency acoustic unit 13. It should be noted that when the third sound guiding hole fully overlaps with one of the two sound guiding holes (e.g., the first sound guiding hole 111 and the second sound guiding hole 112) corresponding to the low-frequency acoustic unit 13, the third sound guiding hole and the fully coinciding sound guiding hole may collectively be regarded as one sound guiding hole.

It should be understood that the block diagram provided in FIG. 2 is for illustrative purposes only and is not intended to limit the scope of the present disclosure. Those skilled in the art may make various modifications and changes under the guidance of the present disclosure, and such modifications and changes shall fall within the protection scope of the present disclosure. In some embodiments, the count of components shown in the drawings may be adjusted according to actual circumstances. In some embodiments, one or more components shown in FIG. 2 may be omitted, or one or more other components may be added or removed. For example, the acoustic output device 10 may not include the support structure 12, and the housing 11 may possess the wearing and securing functions of the support structure 12. In some embodiments, one component may be replaced by another component capable of achieving similar functions. In some embodiments, one component may be split into multiple sub-components, or multiple components may be combined into a single component. For example, the housing 11 and the support structure 12 may be combined into a single component.

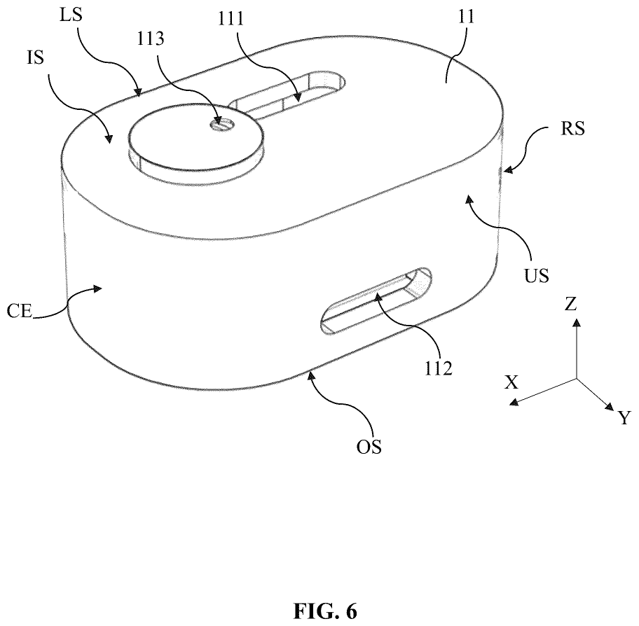

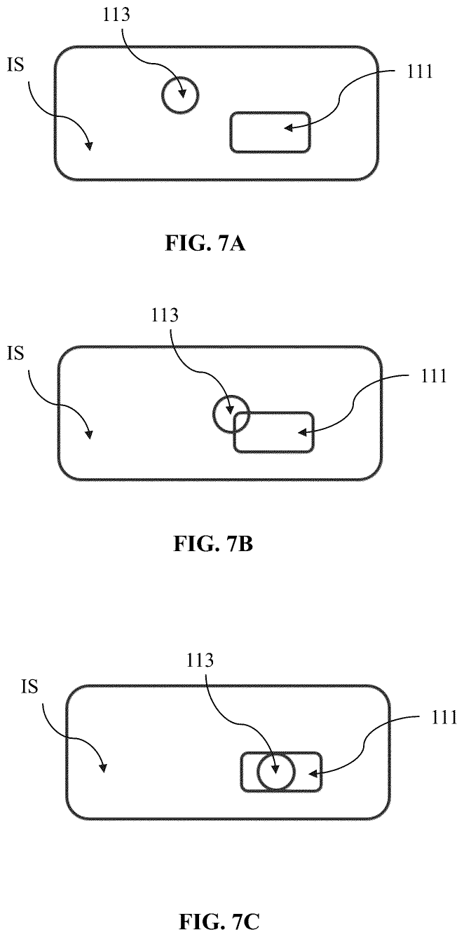

FIG. 6 is a schematic diagram of an external contour of a housing according to some embodiments of the present disclosure. FIG. 7A to FIG. 7C are schematic diagrams showing positions of a first sound guiding hole and a third sound guiding hole according to some embodiments of the present disclosure. As shown in FIG. 4 and FIG. 6, in some embodiments, the at least two sound guiding holes on the housing 11 may include a first sound guiding hole 111, a second sound guiding hole 112, and a third sound guiding hole 113. The first sound guiding hole 111 and the second sound guiding hole 112 are acoustically coupled to two sides of the diaphragm of the low-frequency acoustic unit 13, respectively. In some embodiments, the first sound guiding hole 111 may be provided on a side of the housing 11 facing the auricle. The diaphragm of the low-frequency acoustic unit 13 may divide the housing 11 into a front cavity and a back cavity. The first sound guiding hole 111 may be in communication with the front cavity and direct sound generated in the front cavity out of the housing 11 toward the user's ear canal, enabling the user to hear the sound. In some embodiments, a portion of the sound emitted through the first sound guiding hole 111 may propagate to the ear canal for the user to hear, and another portion of the sound may, along with sound reflected from the ear canal, propagate through a gap between the housing 11 and the ear (e.g., a portion of the cavum concha not covered by the housing 11) to the exterior of the acoustic output device 10 and the ear, thereby forming a first sound leakage in the far field. Simultaneously, the second sound guiding hole 112 may be provided on another side (e.g., the side away from or opposite to the user's ear canal) of the housing 11. The second sound guiding hole 112 is farther from the ear canal compared to the first sound guiding hole 111. Sound propagating from the second sound guiding hole 112 generally forms a second sound leakage in the far field. The intensity of the first sound leakage and the intensity of the second sound leakage are comparable, and the phase of the first sound leakage and the phase of the second sound leakage are (approximately) opposite. This configuration enables the first sound leakage and the second sound leakage to cancel each other out through destructive interference in the far field, thereby contributing to the reduction of sound leakage at low frequencies for the acoustic output device 10 and giving the device dipole directivity in the low-frequency range (e.g., 100 Hz-800 Hz). In some embodiments, the third sound guiding hole 113 is acoustically coupled to one side of the diaphragm of the high-frequency acoustic unit 14 and is arranged to face toward the user's ear canal. The high-frequency acoustic unit 14 outputs the third sound wave solely through the third sound guiding hole 113, making the third sound guiding hole 113 be the sound source of the third sound wave. Since the wavelength of the high-frequency sound wave generated by the high-frequency acoustic unit 14 is short and comparable to the size of the third sound guiding hole 113 through which the third sound wave is output, the sound source of the third sound wave cannot be treated as a point source but rather as a surface source. The sound field received at a specific point in the far field of the acoustic output device 10 may be regarded as the superposition of countless point sources on the radiation surface of the surface source. Due to differences in acoustic path lengths between these point sources and the reception point, the received third sound wave at that position is frequency- and wavelength-dependent. The higher the frequency of the third sound wave, the sharper and better the directivity of the sound field of the high-frequency acoustic unit 14. As the frequency of the third sound wave output by the high-frequency acoustic unit 14 via the third sound guiding hole 113 is high, its directivity is consequently good. This enhances the listening effect of the third sound wave output by the high-frequency acoustic unit 14 at the user's ear and ensures the acoustic output performance of the acoustic output device 10 in the full frequency range.

In some embodiments, the first sound guiding hole 111, the second sound guiding hole 112, and the third sound guiding hole 113 are provided at different positions on the housing 11. In some embodiments, to enhance the sound volume at the user's ear canal opening, the first sound guiding hole 111 and the third sound guiding hole 113 may be provided at positions on the housing 11 that are closer to the user's ear canal opening, such as on a sidewall of the housing 11 facing the user's ear canal opening. The second sound guiding hole 112 may be provided at a position on the housing 11 that is away from the user's ear canal opening, such as on a sidewall of the housing 11 away from the user's ear canal opening, to prevent the second sound wave emitted therefrom from causing destructive interference with the first sound wave emitted from the first sound guiding hole 111 near the user's ear canal opening, which may affect the listening experience. In some embodiments, as shown in FIG. 7A to FIG. 7C, the first sound guiding hole 111 and the third sound guiding hole 113 may be provided on the same sidewall of the housing 11, allowing both the first sound guiding hole 111 and the third sound guiding hole 113 to face the user's ear canal opening, thereby improving the sound volume at the user's ear canal opening. In some embodiments, as shown in FIG. 7A, on the sidewall where the first sound guiding hole 111 is located, the third sound guiding hole 113 may be positioned at any position other than the first sound guiding hole 111. This arrangement not only reduces the design difficulty of orienting the third sound guiding hole 113 toward the user's ear canal opening but also allows greater flexibility in positioning the high-frequency acoustic unit 14.

In some embodiments, the second sound guiding hole 112 and the first sound guiding hole 111 are provided on two sides of the diaphragm of the low-frequency acoustic unit 13, and the second sound guiding hole 112 is arranged away from the user's ear canal opening. For example, if a first sidewall of the housing 11 faces the user's ear canal opening, the first sound guiding hole 111 may be provided on the first sidewall, and the second sound guiding hole 112 may be provided on a third sidewall opposite to the first sidewall and is oriented away from the user's ear canal opening. Alternatively, the second sound guiding hole 112 may be provided on a second sidewall adjacent to the first sidewall and is oriented away from the user's ear canal opening. This arrangement ensures that, in the wearing state of the acoustic output device 10, the first sound guiding hole 111 faces the user's ear canal opening, while the second sound guiding hole 112 is oriented away from the user's ear canal opening. The sound emitted from the first sound guiding hole 111 and the sound emitted from the second sound guiding hole 112 under specific conditions (e.g., with a phase difference of approximately 180°) may form dipole-like radiation. In the far field, the sound from the first sound guiding hole 111 and the sound from the second sound guiding hole 112 may cancel each other out due to their opposite phases, thereby reducing the sound leakage volume of the low-frequency acoustic unit 13 in the far field and preventing the low-frequency sound output by the acoustic output device 10 from being heard by nearby individuals.

When the user wears the acoustic output device, to ensure the sound volume at the user's ear canal opening and the sound leakage reduction effect of the low-frequency acoustic unit 13 in the far field, a ratio of a distance between the second sound guiding hole 112 and the user's ear canal opening to a distance between the first sound guiding hole 111 and the user's ear canal opening should be maximized. In some embodiments, the ratio of the distance between the second sound guiding hole 112 and the user's ear canal opening to the distance between the first sound guiding hole 111 and the user's ear canal opening may be greater than 1.2. In some embodiments, to further ensure the sound volume at the user's ear canal opening and the sound leakage reduction effect of the low-frequency acoustic unit 13 in the far field, the ratio of the distance between the second sound guiding hole 112 and the user's ear canal opening to the distance between the first sound guiding hole 111 and the user's ear canal opening may range from 1.2 to 8. In some embodiments, to further ensure the sound volume at the user's ear canal opening and the sound leakage reduction effect of the low-frequency acoustic unit 13 in the far field, the ratio of the distance between the second sound guiding hole 112 and the user's ear canal opening to the distance between the first sound guiding hole 111 and the user's ear canal opening may range from 1.4 to 5. In some embodiments, to further ensure the sound volume at the user's ear canal opening and the sound leakage reduction effect of the low-frequency acoustic unit 13 in the far field, the ratio of the distance between the second sound guiding hole 112 and the user's ear canal opening to the distance between the first sound guiding hole 111 and the user's ear canal opening may range from 1.5 to 2.5.

In some embodiments, to ensure that the user hears a relatively large volume when wearing the acoustic output device 10, the distance between the first sound guiding hole 111 and the user's ear canal opening should be minimized. The distance between the first sound guiding hole 111 and the user's ear canal opening refers to a distance between a center of the first sound guiding hole 111 and a centroid of a contour of the user's ear canal opening. The distance between the first sound guiding hole 111 and the user's ear canal opening refers to a distance between the center of the first sound guiding hole 111 and a central point of the user's ear canal opening, or a distance from the center of the first sound guiding hole 111 to a plane on which the user's ear canal opening is located. In some embodiments, the distance between the first sound guiding hole 111 and the user's ear canal opening may be less than 4 cm. In some embodiments, to further ensure the user's listening volume, the distance between the first sound guiding hole 111 and the user's ear canal opening may be less than 3 cm. In some embodiments, to ensure the ear canal opening remains open, the first sound guiding hole 111 must maintain a certain distance from the ear canal opening, and the distance between the first sound guiding hole 111 and the user's ear canal opening may range from 0.5 cm to 2.5 cm. In some embodiments, to further ensure the openness of the ear canal opening, the distance between the first sound guiding hole 111 and the user's ear canal opening may range from 1 cm to 3.1 cm.

When the user wears the acoustic output device 10, if the distance between the second sound guiding hole 112 and the user's ear canal opening is too small, the sound emitted from the second sound guiding hole 112 near the ear canal opening may cancel out the sound emitted from the first sound guiding hole 111. To ensure adequate sound volume at the user's ear canal opening and reduce sound leakage in the far field, in some embodiments, the distance between the second sound guiding hole 112 and the user's ear canal opening may be greater than 1 cm. Additionally, if the distance between the first sound guiding hole 111 and the second sound guiding hole 112 is too large, or if the distance between the second sound guiding hole 112 and the ear canal opening is too large, the size of the acoustic output device 10 may be too large, negatively impacting the user's wearing experience. To ensure user comfort, in some embodiments, the distance between the second sound guiding hole 112 and the user's ear canal opening may be less than 8 cm. In some embodiments, to further ensure the low-frequency output performance of the acoustic output device 10, the distance between the second sound guiding hole 112 and the user's ear canal opening may range from 1.5 cm to 7 cm. In some embodiments, to further ensure the sound volume at the user's ear canal opening and the sound leakage reduction effect of the low-frequency acoustic unit 13 in the far field, the distance between the second sound guiding hole 112 and the user's ear canal opening may range from 2.5 cm to 4 cm.

In some embodiments, to prevent the second sound wave emitted from the second sound guiding hole 112 from destructively interfering with the first sound wave emitted from the first sound guiding hole 111 in the near field, which may degrade the user's listening quality, a distance between the second sound guiding hole 112 and the first sound guiding hole 111 should not be too small. The distance between the second sound guiding hole 112 and the first sound guiding hole 111 refers to a distance between a center of the second sound guiding hole 112 and the center of the first sound guiding hole 111. In some embodiments, the distance between the second sound guiding hole 112 and the first sound guiding hole 111 may range from 4 mm to 15.11 mm. In some embodiments, to further ensure the user's listening quality, the distance between the second sound guiding hole 112 and the first sound guiding hole 111 may range from 8 mm to 10 mm.

In some embodiments, the third sound guiding hole 113 is positioned closer to the user's ear canal compared to the first sound guiding hole 111 and the second sound guiding hole 112. Combined with the third sound guiding hole's 113 orientation toward the user's ear canal, this configuration allows the ear canal opening to receive more high-frequency sound, ensuring that the sound pressure level at the ear canal opening is sufficiently high, thereby guaranteeing effective high-frequency listening. In some embodiments, the distance between the third sound guiding hole 113 and the user's ear canal opening may be less than 2.5 cm. In some embodiments, to further ensure the user's high-frequency listening experience, the distance between the third sound guiding hole 113 and the user's ear canal opening may be less than 1 cm. In some embodiments, to ensure that the ear canal opening remains open, the third sound guiding hole 113 must maintain a certain distance from the ear canal opening, and the distance between the third sound guiding hole 113 and the user's ear canal opening may range from 0.1 cm to 1.5 cm. In some embodiments, to further ensure that the ear canal opening remains open, the distance between the third sound guiding hole 113 and the user's ear canal opening may range from 0.5 cm to 2.5 cm.

Referring to FIG. 1, FIG. 3, and FIG. 6, in some embodiments, the housing 11 may include a sidewall (also referred to as an inner side surface IS) facing the anterolateral surface of the user's auricle and a sidewall (also referred to as an outer side surface OS) facing away from the anterolateral surface of the user's auricle.

In some embodiments, in the wearing state, the inner side surface IS faces the auricle along the thickness direction Z, and the outer side surface OS is away from the auricle along the thickness direction Z. In some embodiments, the housing 11 may also include a connecting surface linking the inner side surface IS and the outer side surface OS. It should be noted that, when viewed along the thickness direction Z in the wearing state, the housing 11 may be shaped as a circle, an ellipse, a rounded square, a rounded rectangle, etc. When the housing 11 is circular, elliptical, etc., the aforementioned connecting surface refers to a curved side surface of the housing 11. When the housing 11 is a rounded square, a rounded rectangle, etc., the connecting surface may include a lower side surface LS, an upper side surface US, and a rear side surface RS. Therefore, for ease of description, this embodiment takes the housing 11 as a rounded rectangular as an example for illustration. A length of the housing 11 along the long-axis direction X may be greater than a width of the housing 11 along the short-axis direction Y. As shown in FIG. 3 and FIG. 6, the housing 11 may have an upper side surface US that faces away from the ear canal 101 along the short-axis direction Y in the wearing state, a lower side surface LS that faces toward the ear canal 101, and a rear side surface RS connecting the upper side surface US and the lower side surface LS. The rear side surface RS is located at an end of the long-axis direction X facing toward the back of the head in the wearing state.

In some embodiments, the high-frequency acoustic unit 14 and the low-frequency acoustic unit 13 may be designed in a stacked configuration along the thickness direction Z. This configuration allows both the first sound guiding hole 111 and the third sound guiding hole 113 to be positioned on the inner side surface IS, thereby bringing the first sound guiding hole 111 and the third sound guiding hole 113 closer to the user's ear canal and enhancing the sound volume at the ear canal opening. The stacked configuration along the thickness direction Z means that the high-frequency acoustic unit 14 is located above (e.g., directly above, diagonally above, etc.) or below (e.g., directly below, diagonally below, etc.) the low-frequency acoustic unit 13 in the thickness direction Z. That is to say, along the thickness direction Z, the high-frequency acoustic unit 14 is closer to the outer side surface OS or the inner side surface IS compared to the low-frequency acoustic unit 13. In some embodiments, the second sound guiding hole 112 may be positioned on other sidewalls (e.g., the upper side surface US, the rear side surface RS, the outer side surface OS, etc.) of the housing 11 that are farther from the user's ear. This arrangement ensures an appropriate distance between the second sound guiding hole 112 and the user's ear canal opening, thereby maintaining adequate sound volume at the ear canal opening and achieving the sound leakage reduction effect of the low-frequency acoustic unit 13 in the far field.

Referring to FIG. 7C, in some embodiments, the first sound guiding hole 111 may fully overlap with the third sound guiding hole 113. In this case, the first sound guiding hole 111 and the third sound guiding hole 113 may be regarded as one sound guiding hole, and the sound guiding hole with the larger area is the one sound guiding hole. Taking the first sound guiding hole 111 as an example, the first sound guiding hole 111 is acoustically coupled to one side of the diaphragm of the low-frequency acoustic unit 13 and one side of the diaphragm of the high-frequency acoustic unit 14 simultaneously. Both the low-frequency acoustic unit 13 and the high-frequency acoustic unit 14 radiate sound toward the user's ear canal through the one sound guiding hole.

Referring to FIG. 7B, in some embodiments, the first sound guiding hole 111 may partially overlap with the third sound guiding hole 113. In this case, the first sound guiding hole 111 and the third sound guiding hole 113 may also be regarded as one sound guiding hole, which includes a first region (a non-overlapping portion of the first sound guiding hole 111), a second region (a non-overlapping portion of the third sound guiding hole 113), and a third region (an overlapping portion between the first sound guiding hole and the third sound guiding hole). The first region and the third region of the sound guiding hole are acoustically coupled to one side of the diaphragm of the low-frequency acoustic unit 13, allowing the low-frequency acoustic unit 13 to radiate sound toward the user's ear canal through the first region and the third region. The second region and the third region are acoustically coupled to one side of the diaphragm of the high-frequency acoustic unit 14, allowing the high-frequency acoustic unit 14 to radiate sound toward the user's ear canal through the second region and the third region.

Referring to FIG. 7A, when the first sound guiding hole 111 and the third sound guiding hole 113 do not overlap, the third sound guiding hole 113 may be positioned at any position other than the first sound guiding hole 111. This not only reduces the design difficulty of orienting the third sound guiding hole 113 toward the user's ear canal opening but also increases the flexibility in positioning the high-frequency acoustic unit 14. Additionally, the high-frequency acoustic unit 14 may be arranged to protrude relative to the inner side surface IS of the housing 11 or embedded within the housing 11 at a position corresponding to the inner side surface IS, further enhancing the installation flexibility of the high-frequency acoustic unit 14.

Referring to FIG. 7B and FIG. 7C, when the first sound guiding hole 111 and the third sound guiding hole 113 have overlapping portions, the first sound guiding hole 111 and the third sound guiding hole 113 must lie in the same plane. In this case, the high-frequency acoustic unit 14 may be embedded within the housing 11 at a position corresponding to the inner side surface IS. The first sound guiding hole 111 and the third sound guiding hole 113 may be regarded as one sound guiding hole. The design of a single sound guiding hole simplifies the structure and reduces manufacturing and design difficulties. Moreover, since the high-frequency acoustic unit 14 is embedded within the housing 11, it does not protrude beyond the surface of the housing 11, resulting in a smooth surface and an aesthetically pleasing form.

In some wearing states, since both the third sound guiding hole 113 and the first sound guiding hole 111 are located on the inner side surface IS, and the high-frequency acoustic unit 14 is arranged on the housing 11 corresponding to the inner side surface IS, the high-frequency acoustic unit 14 may potentially obstruct the first sound guiding hole 111. This arrangement may reduce the sound output from the low-frequency acoustic unit 13 through the first sound guiding hole 111, thereby affecting the low-frequency sound volume at the user's ear canal. Therefore, the high-frequency acoustic unit 14 may be arranged to avoid the first sound guiding hole 111 as much as possible.

In some embodiments, to prevent the high-frequency acoustic unit 14 from blocking the first sound guiding hole 111 and ensure the user's low-frequency listening volume, an overlap ratio between a projection area of the high-frequency acoustic unit 14 on the inner side surface IS of the housing 11 and a projection area of the sound guiding hole (i.e., the first sound guiding hole 111) of the low-frequency acoustic unit 13 on the inner side surface IS may not exceed 10%. That is to say, a ratio of the overlapping area to an area of the first sound guiding hole 111 may not exceed 10%. In some embodiments, to further ensure the low-frequency listening volume at the user's ear canal, the overlap ratio between the projection area of the high-frequency acoustic unit 14 on the inner side surface IS of the housing 11 and the projection area of the sound guiding hole (i.e., the first sound guiding hole 111) of the low-frequency acoustic unit 13 on the inner side surface IS may not exceed 8%. In some embodiments, to further ensure the low-frequency listening volume at the user's ear canal, the overlap ratio between the projection area of the high-frequency acoustic unit 14 on the inner side surface IS of the housing 11 and the projection area of the sound guiding hole (i.e., the first sound guiding hole 111) of the low-frequency acoustic unit 13 on the inner side surface IS may not exceed 5%.

To ensure that the user's ear canal opening receives sufficient high-frequency sound and maintains an adequate sound pressure level for optimal high-frequency listening performance, in some embodiments, the third sound guiding hole 113 is positioned closer to the user's ear canal than the first sound guiding hole 111 on the inner side surface IS in the wearing state. The position of the third sound guiding hole 113 corresponds to the position of the high-frequency acoustic unit 14 on the inner side surface IS of the housing 11, i.e., the high-frequency acoustic unit 14 is located closer to the user's ear canal compared to the first sound guiding hole 111. In some embodiments, the position of the high-frequency acoustic unit 14 on the inner side surface IS may be represented by a centroid of a projection of the high-frequency acoustic unit 14 on the inner side surface IS. That is to say, the centroid of the projection of the high-frequency acoustic unit 14 on the inner side surface IS is closer to the user's ear canal than the sound guiding hole (i.e., the first sound guiding hole 111) of the low-frequency acoustic unit 13 on the inner side surface IS.

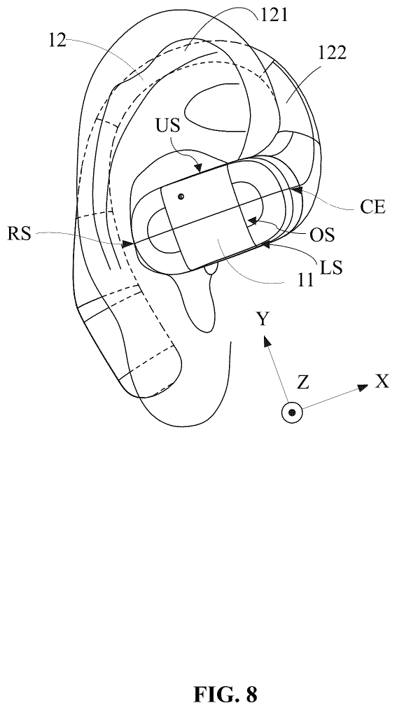

FIG. 8 is a wearing schematic diagram showing a housing of an acoustic output device extending into a cavum concha according to some embodiments of the present disclosure. Referring to FIG. 8, in some embodiments, the housing 11 may have a connection end CE connected to the support structure 12. When the acoustic output device 10 is in the wearing state, the first portion 121 of the support structure 12 is hooked between the user's auricle and head, and the second portion 122 of the support structure 12 extends toward a side of the auricle facing away from the head and connects to the connection end CE of the housing 11 to achieve clamped fixation of the housing 11.

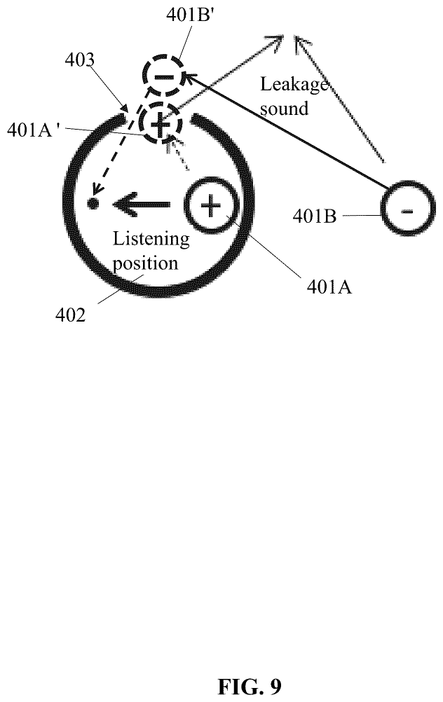

By extending at least a portion of the housing 11 into the cavum concha 102, the sound volume at the listening position (e.g., the ear canal) can be improved, particularly for mid-to-low frequencies, while still maintaining effective far-field sound leakage cancellation. Merely by way of example, when the entire or partial structure of the housing 11 extends into the cavum concha 102, the housing 11 and the cavum concha 102 form a structure resembling a cavity (hereinafter referred to as a “cavity-like structure”). In the embodiments of the present disclosure, the cavity-like structure may be understood as a semi-enclosed structure formed by a side surface of the housing 11 and the structure of the cavum concha 102. The semi-enclosed structure is not completely sealed from the external environment but has leakage structures (e.g., openings, gaps, channels, etc.) that provide acoustic communication with the external environment. When the user wears the acoustic output device 10, one or more sound guiding holes, such as the first sound guiding hole 111, may be provided on a side (e.g., the inner side surface IS) of the housing 11 near or facing toward the user's ear canal. One or more other sound guiding holes, such as the second sound guiding hole 112, may be provided on other sides (e.g., the outer side surface OS distant from or facing away from the user's ear canal) of the housing 11. The first sound guiding hole 111 is acoustically coupled to the front cavity of the acoustic output device 10, and the second sound guiding hole 112 is acoustically coupled to the back cavity of the acoustic output device 10. The sound emitted from the first sound guiding hole 111 and the sound emitted from the second sound guiding hole 112 may be approximately regarded as two sound sources with opposite phases. The housing 11 and an inner wall of the auricle corresponding to the cavum concha 102 form the cavity-like structure. The sound source corresponding to the first sound guiding hole 111 is located inside the cavity-like structure, and the sound source corresponding to the second sound guiding hole 112 is located outside the cavity-like structure, forming an acoustic model shown in FIG. 9.

FIG. 9 is a schematic diagram of an acoustic model formed by an acoustic output device according to some embodiments of the present disclosure. As shown in FIG. 9, a cavity-like structure 402 may contain a listening position and at least one sound source 401A. The term “contain” may indicate that at least one of the listening position and the sound source 401A is inside the cavity-like structure 402, or at least one of the listening position and the sound source 401A is at an inner edge of the cavity-like structure 402. The listening position may be equivalent to the ear canal opening, or an acoustic reference point of the auricle, such as an ear reference point (ERP), an ear-drum reference point (DRP), etc., or may be an entrance structure directed toward a listener. Since the sound source 401A is wrapped by the cavity-like structure 402, a large portion of the sound emitted by the sound source 401A may reach the listening position through direct radiation or reflection. In contrast, without the cavity-like structure 402, a large portion of the sound emitted by the sound source 401A may not reach the listening position. Therefore, the cavity-like structure significantly increases the sound volume reaching the listening position. Simultaneously, only a small portion of sound with an opposite phase emitted by an anti-phase sound source 401B outside the cavity-like structure 402 enters the cavity-like structure 402 through a leakage structure 403 of the cavity-like structure. This is equivalent to generating a secondary sound source 401B′ at the leakage structure 403, whose intensity is significantly lower than that of sound source 401B and also significantly lower than that of the sound source 401A. The sound generated by the secondary sound source 401B′ has a weak anti-phase cancellation effect on sound source 401A within the cavity, resulting in a significant increase in sound volume at the listening position. Regarding sound leakage, the sound radiated by sound source 401A to the external environment through the leakage structure 403 of the cavity is equivalent to generating a secondary sound source 401A′ at the leakage structure 403. Since almost all of the sound radiated by sound source 401A is output through the leakage structure 403, and the scale of the cavity-like structure 402 is much smaller than the spatial scale for evaluating sound leakage (differing by at least one order of magnitude), the intensity of the secondary sound source 401A′ may be considered comparable to that of the sound source 401A. For the external space, the secondary sound source 401A′ and the sound source 401B form a dual-source cancellation configuration that cancels each other out to reduce sound leakage.

In specific application scenarios, the outer wall surface of the housing 11 is typically planar or curved, and the contour of the user's cavum concha 102 has an uneven structure. By extending part or all of the housing 11 into the cavum concha 102, the cavity-like structure communicating with the external environment is formed between the housing 11 and the contour of the cavum concha 102. Furthermore, by providing the first sound guiding hole 111 on the side (e.g., the inner side surface IS) of the housing 11 facing the user's ear canal and close to the edge of the cavum concha 102, and providing the second sound guiding hole 112 on the side of the housing 11 facing away from or distant from the ear canal, the acoustic model shown in FIG. 9 may be constructed. This enables the acoustic output device 10, when worn by the user, to enhance the sound volume at the listening position near the ear canal opening and reduce sound leakage in the far field.

As shown in FIG. 8, when at least a portion of the housing 11 extends into the cavum concha, the housing 11 is inclined in the wearing state. For specific details, please refer to the relevant description of the dashed-line box B in FIG. 3, which will not be repeated here. In this configuration, the connection end CE is closer to the user's ear canal, while the rear side surface RS is farther from the user's ear canal compared to the connection end CE. Additionally, due to the need to abut against the cavum concha, a portion of the inner side surface IS near the rear side surface RS may contact the cavum concha. In some embodiments, the centroid of the projection of the high-frequency acoustic unit 14 on the inner side surface IS is closer to the connection end CE compared to the sound guiding hole (the first sound guiding hole 111) of the low-frequency acoustic unit 13 on the inner side surface IS. This arrangement ensures that the third sound guiding hole 113 is positioned closer to the user's ear canal than the first sound guiding hole 111, maintaining the directivity of the third sound guiding hole 113 and thereby guaranteeing high-frequency listening performance.

In some embodiments, even when the housing 11 does not extend into the cavum concha, the housing 11 may still be inclined in the wearing state, with the connection end CE closer to the user's ear canal and the rear side surface RS farther from the user's ear canal. In this case, the centroid of the projection of the high-frequency acoustic unit 14 on the inner side surface IS is also closer to the connection end CE compared to the sound guiding hole (the first sound guiding hole 111) of the low-frequency acoustic unit 13 on the inner side surface IS.

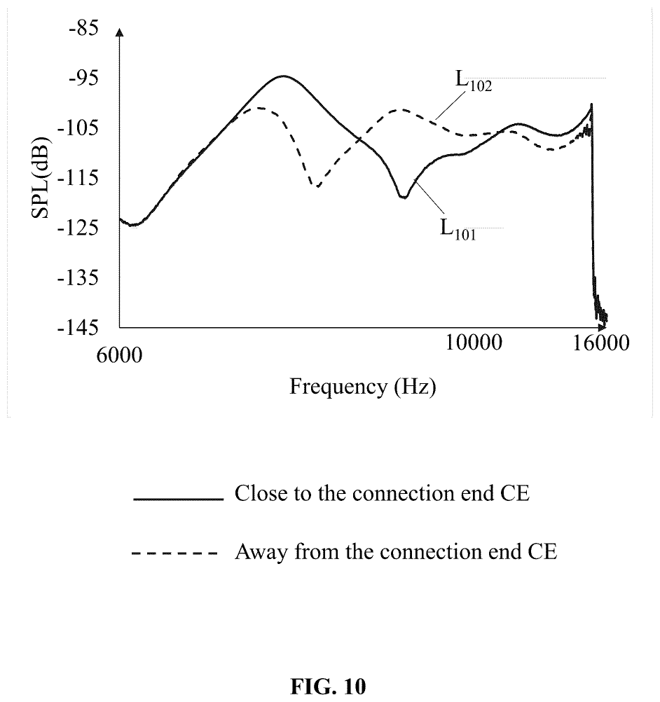

FIG. 10 is a schematic diagram of frequency response curves of an acoustic output device corresponding to different placement positions of a high-frequency acoustic unit according to some embodiments of the present disclosure. Referring to FIG. 10, curve L₁₀₁ represents a frequency response curve of the acoustic output device 10 when the high-frequency acoustic unit 14 is positioned near the connection end CE of the housing 11. That is to say, curve L₁₀₁ corresponds to the scenario where the high-frequency acoustic unit 14 is closer to the connection end CE and thus closer to the user's ear canal compared to the first sound guiding hole 111. Curve L₁₀₂ represents a frequency response curve of the acoustic output device 10 when the high-frequency acoustic unit 14 is positioned near the rear side surface RS of the housing 11. That is to say, curve L₁₀₂ corresponds to the scenario where the high-frequency acoustic unit 14 is closer to the rear side surface RS, farther from the connection end CE, and thus farther from the user's ear canal compared to the first sound guiding hole 111. Comparing curves L₁₀₁ and L₁₀₂, it can be seen that in the frequency range of 8 kHz to 10 KHz, curve L₁₀₁ is overall higher and flatter than curve L₁₀₂. This indicates that when the centroid of the projection of the high-frequency acoustic unit 14 on the inner side surface IS is closer to the connection end CE compared to the sound guiding hole (the first sound guiding hole 111) of the low-frequency acoustic unit 13, the acoustic output device 10 achieves a higher output sound pressure level and better sound quality at the user's ear canal.

Referring to FIG. 6 and FIG. 8, in some embodiments, along the short-axis direction Y of the housing 11, the centroid of the projection of the high-frequency acoustic unit 14 on the inner side surface IS is positioned above the sound guiding hole (i.e., the first sound guiding hole 111) of the low-frequency acoustic unit 13 on the inner side surface IS. That is to say, the centroid of the projection of the high-frequency acoustic unit 14 on the inner side surface IS is closer to the upper side surface US compared to the centroid of the projection of the first sound guiding hole 111. This arrangement prevents the high-frequency acoustic unit 14 from blocking the first sound guiding hole 111, which may otherwise reduce the sound output from the low-frequency acoustic unit 13 through the first sound guiding hole 111 and consequently affect the low-frequency listening volume at the user's ear canal. In some embodiments, the centroid of the projection of the high-frequency acoustic unit 14 on the inner side surface IS may be located directly above the first sound guiding hole 111 along the short-axis direction Y. Alternatively, the centroid of the projection of the high-frequency acoustic unit 14 on the inner side surface IS may be positioned diagonally above the first sound guiding hole 111 and closer to the connection end CE along the short-axis direction Y. Or, the centroid of the projection of the high-frequency acoustic unit 14 on the inner side surface IS may be located diagonally above the first sound guiding hole 111 and closer to the rear side surface RS along the short-axis direction Y.

It should be noted that in the wearing state, a free end (i.e., the rear side surface RS) of the housing 11 may not only extend into the cavum concha but may also have its orthographic projection fall on the antihelix, or on positions on the left and right sides of the head that are on the front side of the auricle along the sagittal axis of the human body. In other words, the support structure 12 may support the housing 11 to be worn in various wearing positions, such as the cavum concha, the antihelix, the front side of the auricle, or the rear side of the auricle, enabling the acoustic output device 10 to adapt to multiple wearing styles. For the acoustic output device 10 in certain wearing styles (e.g., worn in the cavum concha or on the rear side of the auricle), by positioning the centroid of the projection of the high-frequency acoustic unit 14 on the inner side surface IS closer to a junction (i.e., the connection end CE) between the support structure 12 and the housing 11 compared to the centroid of the projection of the sound guiding hole (i.e., the first sound guiding hole 111) of the low-frequency acoustic unit 13 on the inner side surface IS, the third sound guiding hole 113 can be positioned closer to the user's ear canal relative to the first sound guiding hole 111, thereby ensuring high-frequency listening performance.

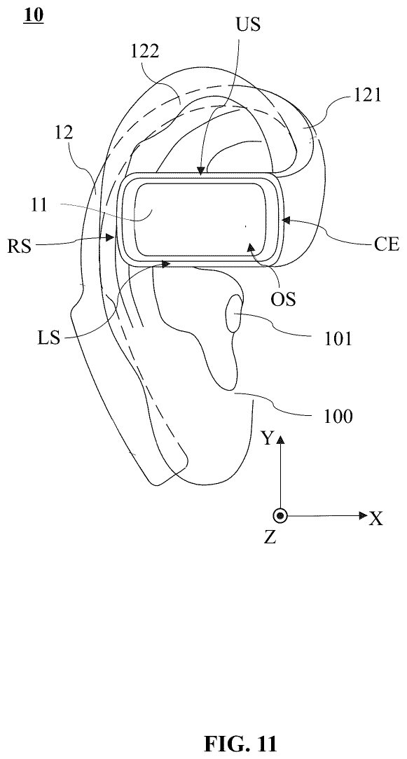

Under different wearing styles, to ensure that the high-frequency acoustic unit 14 is closer to the user's ear canal than the first sound guiding hole 111, the positioning of the high-frequency acoustic unit 14 may need to be adjusted accordingly. The following uses the acoustic output device 10 shown in FIG. 11 as an example for illustration. It should be understood that, without violating the relevant acoustic principles, the structure and corresponding parameters of the acoustic output device 10 in FIG. 11 may also be applied to the acoustic output device 10 mentioned above, in which the housing 11 may extend into the cavum concha.

FIG. 11 is an exemplary wearing schematic diagram of an acoustic output device according to some other embodiments of the present disclosure.

Referring to FIG. 11, in some embodiments, when the acoustic output device 10 is in the wearing state, at least a portion of the housing 11 may cover an antihelix region of the user. The antihelix region may include any one or more of the antihelix 105, the superior antihelix crus 1011, and the inferior antihelix crus 1012 shown in FIG. 1. In this configuration, the housing 11 is positioned above the cavum concha 102 and the ear canal opening, leaving the user's ear canal opening in an open state. In some embodiments, the housing 11 may include a first sound guiding hole 111 and a second sound guiding hole 112. The first sound guiding hole 111 is acoustically coupled to the front cavity of the acoustic output device 10, and the second sound guiding hole 112 is acoustically coupled to the back cavity of the acoustic output device 10. The sound emitted from the first sound guiding hole 111 and the sound emitted from the second sound guiding hole 112 may be approximately regarded as two point sound sources with opposite phases, forming a dipole. When the user wears the acoustic output device 10, the first sound guiding hole 111 is located on a sidewall of the housing 11 facing or close to the user's ear canal opening, and the second sound guiding hole 112 is located on a sidewall of the housing 11 distant from or facing away from the user's ear canal opening. This configuration ensures that the user's ear canal remains completely open, maintaining the acoustic performance of the acoustic output device 10 while allowing the user to hear external sounds more clearly, thereby enhancing the open-ear listening experience. In the wearing state, the inner side surface IS of the housing 11 rests against the antihelix region. The uneven structure of the antihelix region acts as a baffle, increasing the acoustic path length for sound propagating from the second sound guiding hole 112 to the external ear canal. This arrangement enlarges a difference between an acoustic path from the first sound guiding hole 111 to the external ear canal and an acoustic path from the second sound guiding hole 112 to the external ear canal, reduces destructive interference between the first sound guiding hole 111 and the second sound guiding hole 112 at the listening position, and increases the sound intensity at a near-field listening position.

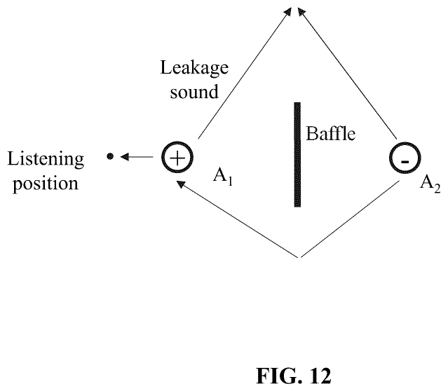

As shown in FIG. 11, by positioning at least a portion of the housing 11 at the user's antihelix 105, the acoustic output performance of the acoustic output device 10 can be improved. This configuration ensures far-field sound leakage reduction while simultaneously increasing the sound intensity at the near-field listening position. The sound emitted from the first sound guiding hole 111 can propagate directly and unobstructed to the user's ear canal opening, and the sound emitted from the second sound guiding hole 112 needs to bypass or traverse around the housing 11, forming an acoustic model similar to the acoustic model shown in FIG. 12.

FIG. 12 is a schematic diagram of an acoustic model formed by an acoustic output device according to yet some other embodiments of the present disclosure. As shown in FIG. 12, when a baffle is placed between a point sound source A₁ and a point sound source A₂, in the near field, a sound field of the point sound source A₂ must bypass the baffle to interfere with a sound wave from the point sound source A₁ at the listening position, which is equivalent to increasing the acoustic path length from the point sound source A₂ to the listening position. Therefore, assuming that the point sound source A₁ and the point sound source A₂ have the same amplitude, compared to the scenario without a baffle, an amplitude difference between the sound wave from the point sound source A₁ and a sound wave from the point sound source A₂ at the listening position increases, which reduces a degree of destructive interference between the two sound waves at the listening position, thereby increasing the sound volume at the listening position. In the far field, since the sound waves generated by the point sound source A₁ and the point sound source A₂ can interfere over a large spatial range without needing to bypass the baffle (similar to the no-baffle scenario), the far-field sound leakage does not significantly increase compared to the no-baffle case. Thus, placing a baffle structure around one of the point sound source A₁ and the point sound source A₂ can significantly enhance the sound volume at the near-field listening position without substantially increasing the far-field sound leakage volume.

As shown in FIG. 11, the inner side surface IS and the lower side surface LS of the housing 11 are relatively close to the user's ear canal. To position the high-frequency acoustic unit 14 near the user's ear canal, in some embodiments, the high-frequency acoustic unit 14 may be disposed on the lower side surface LS of the housing 11 or at a junction between the lower side surface LS and the inner side surface IS of the housing 11. This arrangement allows the third sound guiding hole 113 of the high-frequency acoustic unit 14 to be better directed toward the user's ear canal, which can increase the high-frequency sound volume at the user's ear canal, thereby compensating for insufficient output of the acoustic output device 10 in the mid-to-high frequency range (e.g., a frequency range with frequencies above 8 kHz), and ensuring that the acoustic output device 10 has good acoustic performance across the full frequency range.

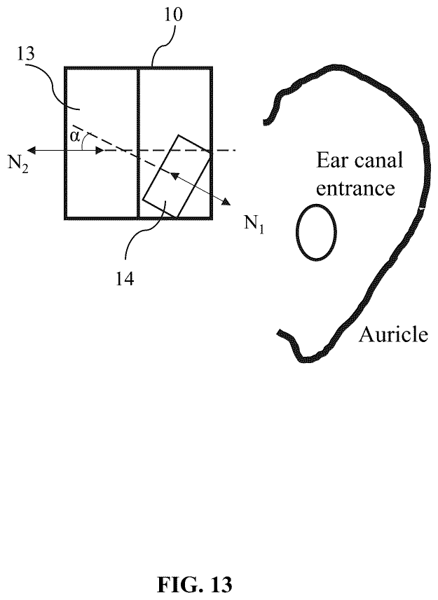

FIG. 13 is a schematic diagram showing a position of an acoustic output device relative to an auricle according to some embodiments of the present disclosure. Referring to FIG. 13, N₁ represents a vibration direction of the diaphragm of the high-frequency acoustic unit 14, and N₂ represents a vibration direction of the diaphragm of the low-frequency acoustic unit 13. In some embodiments, the vibration direction N₂ of the low-frequency acoustic unit 13 is oriented toward the antihelix region of the user, and the first sound guiding hole 111 is directed toward the antihelix of the user. In this configuration, the first sound guiding hole 111 and the second sound guiding hole 112 form a dipole, and the antihelix region acts as a baffle, thereby enhancing the sound volume at the user's ear canal and ensuring optimal listening performance.

The high-frequency acoustic unit 14 outputs sound solely through the third sound guiding hole 113, functioning as a monopole. The high-frequency sound waves produced by the high-frequency acoustic unit 14 have relatively short wavelengths. If the vibration direction N₁ of the high-frequency acoustic unit 14 is oriented toward the user's antihelix region, the sound emitted through the third sound guiding hole 113 may be easily reflected by the ear, adversely affecting the user's high-frequency listening volume. In some embodiments, the vibration direction N₁ of the high-frequency acoustic unit 14 may be oriented toward the user's ear canal, with the third sound guiding hole 113 directed toward the user's ear canal.

In some embodiments, for the dipole formed by the first sound guiding hole 111 and the second sound guiding hole 112, to leverage the user's antihelix as a baffle and increase the difference between the acoustic path from the first sound guiding hole 111 to the user's ear canal opening and the acoustic path from the second sound guiding hole 112 to the user's ear canal opening, thereby enhancing low-frequency listening volume at the ear canal opening, the first sound guiding hole 111 may be designed to face toward the user's ear canal, and the second sound guiding hole 112 may be designed to face away from the user's ear canal or toward the antihelix. In some embodiments, the vibration direction N₂ of the low-frequency acoustic unit 13 may be oriented toward the antihelix region of the user. In some embodiments, to allow the diaphragm of the low-frequency acoustic unit 13 to have a relatively large size and a relatively large vibration space, the diaphragm may be parallel or approximately parallel to the inner side surface IS or the outer side surface OS. With this configuration, the vibration direction N₂ of the low-frequency acoustic unit 13 may be perpendicular or approximately perpendicular to the inner side surface IS or the outer side surface OS. In some embodiments, to ensure that the acoustic output device 10 achieves effective sound leakage reduction and maintains excellent acoustic performance across the full frequency range, an angle α between the vibration direction N₁ of the high-frequency acoustic unit 14 and the vibration direction N₂ of the low-frequency acoustic unit 13 may range from 36° to 54°. In some embodiments, to further enhance the acoustic output performance of the device 10 across the full frequency range and improve the user's listening volume, the angle α between the vibration direction N₁ of the high-frequency acoustic unit 14 and the vibration direction N₂ of the low-frequency acoustic unit 13 may range from 40° to 50°. In some embodiments, to further optimize the acoustic output performance across the full frequency range and maximize the user's listening volume, the angle α between the vibration direction N₁ of the high-frequency acoustic unit 14 and the vibration direction N₂ of the low-frequency acoustic unit 13 may be 45°.

The high-frequency sound waves output by the high-frequency acoustic unit 14 have relatively short wavelengths and are easily absorbed. The relative position of the high-frequency acoustic unit 14 to the housing 11 (e.g., embedded, flush, protruding, etc.) affects the loss of high-frequency sound waves reaching the user's ear canal, further influencing the acoustic output performance of the high-frequency sound waves from the high-frequency acoustic unit 14, and consequently impacting the listening volume at the user's ear canal.

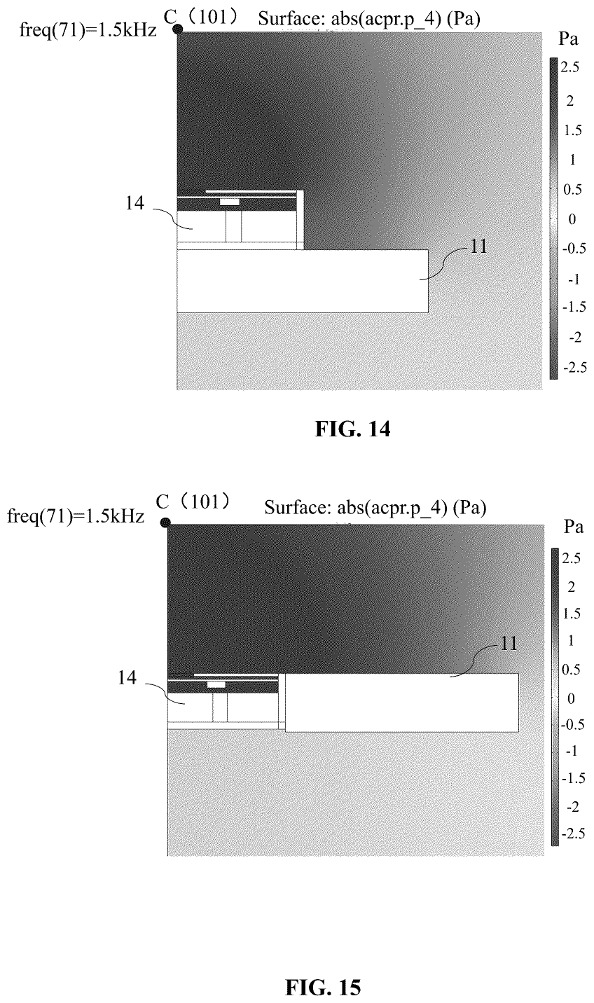

In some embodiments, the inner side surface IS of the housing 11 includes a projection region and a non-projection region of the high-frequency acoustic unit 14. Along the thickness direction Z of the housing 11, the projection region protrudes relative to the non-projection region. In some embodiments, the projection region refers to a region on the inner side surface IS covered by a projection of the high-frequency acoustic unit 14 along the thickness direction Z; the non-projection region refers to a region on the inner side surface IS not covered by the projection of the high-frequency acoustic unit 14. The projection region protruding relative to the non-projection region means that, along the thickness direction Z, the high-frequency acoustic unit 14 is at least partially raised relative to the inner side surface IS, as shown in FIG. 4, FIG. 6, and FIG. 14. By configuring the high-frequency acoustic unit 14 to protrude relative to the inner side surface IS, the high-frequency acoustic unit 14 is closer to the user's ear canal, thereby enhancing the listening volume perceived by the user.

FIG. 14 is a schematic diagram showing a distribution of high-frequency sound waves when a high-frequency acoustic unit is arranged to protrude from a housing according to some embodiments of the present disclosure. As shown in FIG. 14, a bottom portion of the high-frequency acoustic unit 14 is substantially flush with an outer side surface of the housing 11, i.e., the high-frequency acoustic unit is arranged to fully protrude beyond the surface of the housing 11. With this configuration, when a signal with a frequency of 15 kHz is input, the high-frequency sound waves output by the high-frequency acoustic unit 14 approximate spherical waves, and the high-frequency acoustic unit 14 exhibits favorable directivity. The sound pressure level at the user's ear canal 101 (i.e., point C in FIG. 14) is relatively high, and the user perceives a relatively high listening volume.

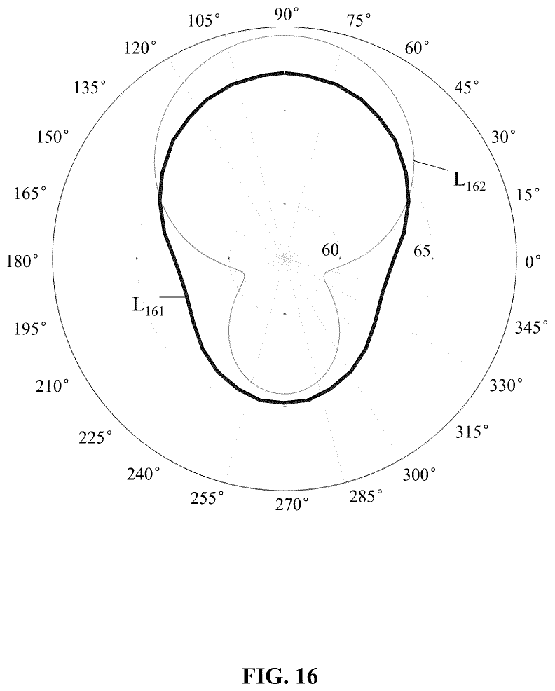

FIG. 15 is a schematic diagram showing a distribution of high-frequency sound waves when a high-frequency acoustic unit is embedded in a housing according to some embodiments of the present disclosure. As shown in FIG. 15, a top portion of the high-frequency acoustic unit 14 is flush with the outer side surface of the housing 11, i.e., the high-frequency acoustic unit is entirely accommodated within the housing 11, with a protrusion height of essentially 0 mm. With this configuration, when a signal with a frequency of 15 kHz is input, the high-frequency sound waves output by the high-frequency acoustic unit 14 approximate spherical waves, and the high-frequency acoustic unit 14 exhibits favorable directivity. Comparing FIG. 14 and FIG. 15, it can be concluded that, relative to the condition where the high-frequency acoustic unit 14 is arranged to protrude beyond the housing 11, when the high-frequency acoustic unit 14 is embedded within the housing 11, the sound pressure level at the user's ear canal 101 (i.e., point C in FIG. 14 and FIG. 15) is relatively higher, the high-frequency sound waves are more concentrated, and the user's listening volume is relatively greater. That is to say, when the high-frequency acoustic unit 14 is embedded within the housing 11, the listening volume at the user's ear canal is relatively higher, and the high-frequency output performance of the acoustic output device 10 is relatively better.

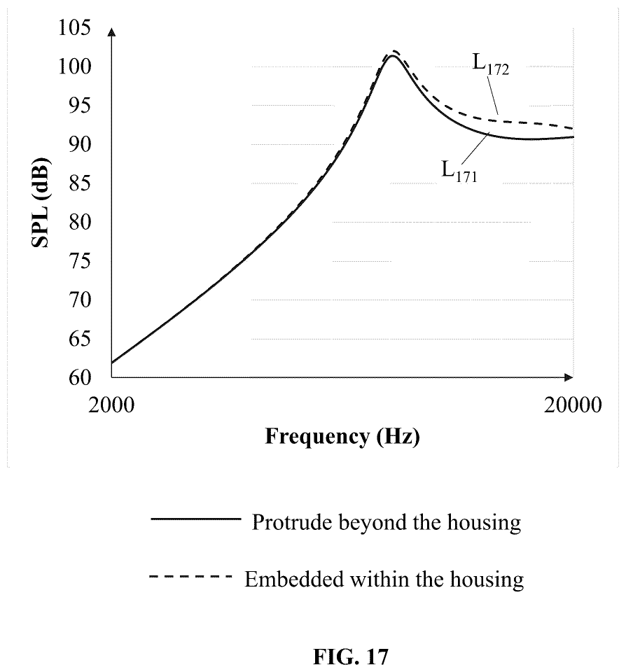

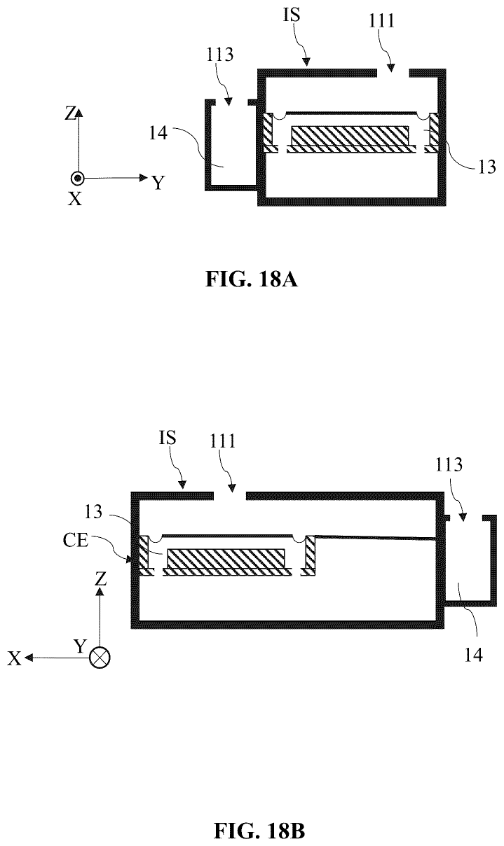

FIG. 16 is a schematic diagram showing the directivity of a high-frequency acoustic unit when the high-frequency acoustic unit is placed at different positions relative to the housing according to some embodiments of the present disclosure. FIG. 17 is a schematic diagram of frequency response curves of a high-frequency acoustic unit when the high-frequency acoustic unit is placed at different positions relative to the housing according to some embodiments of the present disclosure. The image in FIG. 16 corresponds to an input signal frequency of 15 kHz for the high-frequency acoustic unit 14.

Referring to FIG. 16, curve L₁₆₁ represents a far-field directivity distribution of the high-frequency acoustic unit 14 when the high-frequency acoustic unit 14 is arranged to protrude beyond the housing 11. Curve L₁₆₂ represents a far-field directivity distribution of the high-frequency acoustic unit 14 when the high-frequency acoustic unit 14 is embedded within the housing 11. As shown in FIG. 16, curve L₁₆₁ is relatively rounded, while curve L₁₆₂ is relatively sharper, indicating that curve L₁₆₂ has better directivity. In a 90° direction, curve L₁₆₂ significantly protrudes beyond curve L₁₆₁, and in an opposite to the 90° direction, curve L₁₆₁ noticeably protrudes beyond curve L₁₆₂. That is to say, although the high-frequency acoustic unit 14 can achieve good directivity when it is arranged to protrude beyond the housing 11, when the high-frequency acoustic unit 14 is embedded within the housing 11, the far-field sound pressure level is relatively smaller, and the near-field sound pressure level is relatively larger. This results in a relatively higher listening volume at the user's ear canal and reduced sound leakage in the far field.

As can be seen from FIG. 16, the peak values of both curve L₁₆₁ and curve L₁₆₂ are in the 90° direction. For curves L₁₆₁ and L₁₆₂, respectively, reducing by 3 dB from their peak positions yields two points on curve L₁₆₁ and two points on curve L₁₆₂. The angular range between the corresponding two points on each curve represents a −3 dB beamwidth of the respective curve. In some embodiments, the −3 dB beamwidth of curve L₁₆₁ is 141°, and the −3 dB beamwidth of curve L₁₆₂ is 101°. Compared to curve L₁₆₁, curve L₁₆₂ has a smaller −3 dB beamwidth, indicating that curve L₁₆₂ has better directivity.

Referring to FIG. 17, curve L₁₇₁ represents a frequency response curve of the high-frequency acoustic unit 14 when the high-frequency acoustic unit 14 is arranged to protrude beyond the housing 11, and curve L₁₇₂ represents a frequency response curve of the high-frequency acoustic unit 14 when the high-frequency acoustic unit 14 is embedded within the housing 11. As shown in FIG. 17, in the high-frequency range (e.g., above 8 kHz), curve L₁₇₂ is positioned approximately 2 dB higher than curve L₁₇₁. That is to say, in the high-frequency range (e.g., above 8 kHz), compared to the configuration in which the high-frequency acoustic unit 14 is arranged to protrude beyond the housing 11, the output sound pressure level of the high-frequency acoustic unit 14 when the high-frequency acoustic unit 14 is embedded within the housing 11 is increased by approximately 2 dB.

In summary, compared to the configuration in which the high-frequency acoustic unit 14 is arranged to protrude beyond the housing 11, when the high-frequency acoustic unit 14 is embedded within the housing 11, the high-frequency output performance of the high-frequency acoustic unit 14 is better, and the user's listening volume is higher. However, when the high-frequency acoustic unit 14 is fully embedded within the housing 11, the reflection of high-frequency sound waves is reduced, but the loss imposed on the high-frequency sound waves is greater, which, to some extent, affects the propagation distance of the high-frequency sound waves.

In some embodiments, to enhance the high-frequency acoustic output performance of the acoustic output device 10 and reduce the loss of high-frequency sound waves, the projection region and the non-projection region may be flush (i.e., a height difference between the projection region and the non-projection region along the thickness direction Z of the housing 11 is 0 mm). Due to potential machining and installation tolerances, the projection region and the non-projection region may not be absolutely flush. In some embodiments, when the height difference between the projection region and the non-projection region along the thickness direction Z of the housing 11 is less than 0.6 mm, they may be considered approximately flush.

In some embodiments, to enhance the high-frequency acoustic output performance of the acoustic output device 10 and improve the user's listening volume, a ratio of the height difference between the projection region and the non-projection region along the thickness direction Z of the housing 11 to a thickness of the housing 11 may be less than 0.6. In some embodiments, to further improve the high-frequency acoustic output performance, the ratio of the height difference between the projection region and the non-projection region along the thickness direction Z of the housing 11 to the thickness of the housing 11 may range from 0 to 0.3. In some embodiments, to further enhance the user's listening volume, the ratio of the height difference between the projection region and the non-projection region along the thickness direction Z of the housing 11 to the thickness of the housing 11 may range from 0 to 0.1.

It should be noted that in the aforementioned FIG. 14 to FIG. 17, the analysis of the acoustic output performance of the acoustic output device 10 when the high-frequency acoustic unit 14 is arranged to protrude beyond or embedded within the housing 11 is based on an auricle model with “standard” shape and dimensions as a reference. In practical applications, due to variations in user ear morphology (e.g., shape and size), the positional state of the acoustic output device 10 during wearing may differ, and the distance from the sound guiding hole of the high-frequency acoustic unit 14 to the user's ear canal in the wearing state may vary. Consequently, the acoustic output performance of the acoustic output device 10 when the high-frequency acoustic unit 14 is arranged to protrude beyond or embedded within the housing 11 may also change. If the ear of the user has a relatively large size, and the distance between the sound guiding hole corresponding to the high-frequency acoustic unit 14 and the user's ear canal is relatively large in the wearing state, the path loss of high-frequency sound waves may affect the high-frequency output performance of the acoustic output device 10. When the high-frequency acoustic unit 14 is arranged to protrude beyond the housing 11, the distance between its corresponding sound guiding hole and the user's ear canal is relatively short; when the high-frequency acoustic unit 14 is embedded within the housing 11, the distance between its corresponding sound guiding hole and the user's ear canal is relatively long. Therefore, the design where the high-frequency acoustic unit 14 is embedded within the housing 11 (e.g., flush with the housing 11) is relatively more suitable for users with smaller ears, while users with larger ears may have a relatively poorer experience. In contrast, the design where the high-frequency acoustic unit 14 is arranged to protrude beyond the housing 11 can effectively reduce the distance between its corresponding sound guiding hole and the user's ear canal for both users with larger or smaller ears, thereby enabling users with different ear morphologies to achieve optimal listening performance.

In some embodiments, to ensure that the acoustic output device 10 can adapt to a wider range of user ear morphologies, and to guarantee that the sound guiding hole corresponding to the high-frequency acoustic unit 14 maintains a small distance from the user's ear canal in the wearing state for optimal acoustic performance, the high-frequency acoustic unit 14 may be designed to protrude beyond the housing 11. In some embodiments, a degree of protrusion of the high-frequency acoustic unit 14 relative to the inner side surface IS may be represented by the height difference between the projection region and the non-projection region along the thickness direction Z. In some embodiments, when the height difference between the projection region and the non-projection region along the thickness direction Z is not less than 0.6 mm, it may be determined that the high-frequency acoustic unit 14 protrudes beyond the housing 11. That is to say, when a distance between the top portion of the high-frequency acoustic unit 14 and the outer side surface of the housing 11 along the thickness direction Z is not less than 0.6 mm, it may be determined that the high-frequency acoustic unit 14 protrudes beyond the housing 11. In some embodiments, the height difference between the projection region and the non-projection region along the thickness direction Z may not exceed 4 mm to prevent the high-frequency acoustic unit 14 from protruding too much beyond the housing 11, which may affect the wearing of the acoustic output device 10 and potentially cause interference between the sound guiding holes (e.g., the first sound guiding hole 111, etc.) and the user's ear structure, thereby impacting listening performance. In other words, when the high-frequency acoustic unit 14 protrudes from the housing 11, the height difference between the projection region and the non-projection region along the thickness direction Z may range from 0.6 mm to 4 mm. When the high-frequency acoustic unit 14 is designed to protrude beyond the housing 11, the greater the degree of protrusion of the projection region relative to the non-projection region, the easier it is for the high-frequency acoustic unit 14 to approach the user's ear canal, thereby enhancing the user's listening volume. In some embodiments, when the high-frequency acoustic unit 14 is arranged to protrude beyond the housing 11, to further improve the user's listening volume, the height difference between the projection region and the non-projection region along the thickness direction Z may range from 1.5 mm to 3 mm. In some embodiments, when the high-frequency acoustic unit 14 is arranged to protrude beyond the housing 11, to further ensure the wearing comfort of the acoustic output device 10 and guarantee listening performance, the height difference between the projection region and the non-projection region along the thickness direction Z may range from 2 mm to 2.5 mm.

In some embodiments, the degree of protrusion of the high-frequency acoustic unit 14 relative to the inner side surface IS may also be represented by the ratio of the height difference between the projection region and the non-projection region along the thickness direction Z to the thickness of the housing 11 along the thickness direction Z. In some embodiments, when the high-frequency acoustic unit 14 is arranged to protrude beyond the housing 11, to ensure that the acoustic output device 10 achieves good acoustic output performance at high frequencies and maintain the user's listening volume, the ratio of the height difference between the projection region and the non-projection region to the thickness of the housing 11 along the thickness direction Z may be greater than 0.05. In some embodiments, when the high-frequency acoustic unit 14 is arranged to protrude beyond the housing 11, to further ensure the wearing comfort of the acoustic output device 10 and guarantee listening performance, the ratio of the height difference between the projection region and the non-projection region to the thickness of the housing 11 along the thickness direction Z may range from 0.06 to 0.12. In some embodiments, when the high-frequency acoustic unit 14 is arranged to protrude beyond the housing 11, to further enhance the user's listening volume, the ratio of the height difference between the projection region and the non-projection region to the thickness of the housing 11 along the thickness direction Z may range from 0.08 to 0.09.

In some embodiments, the high-frequency acoustic unit 14 may employ a moving iron transducer to enhance the acoustic output performance of the acoustic output device 10.

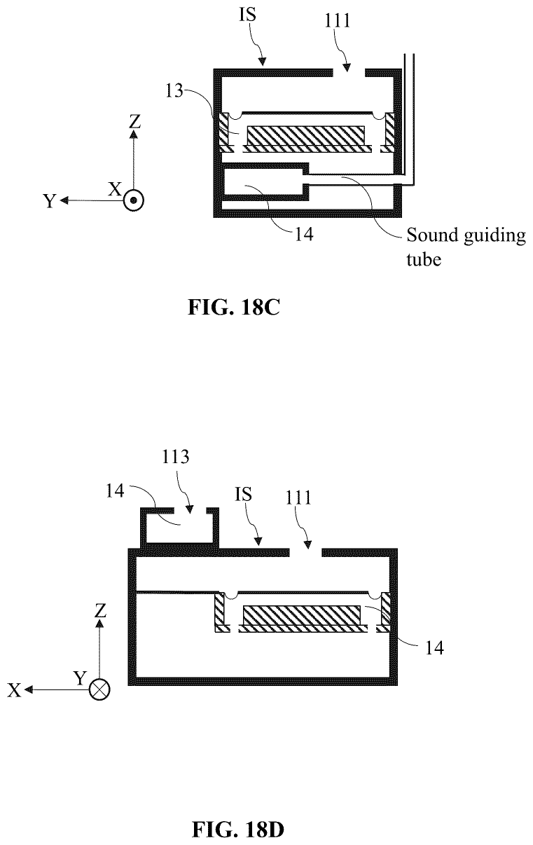

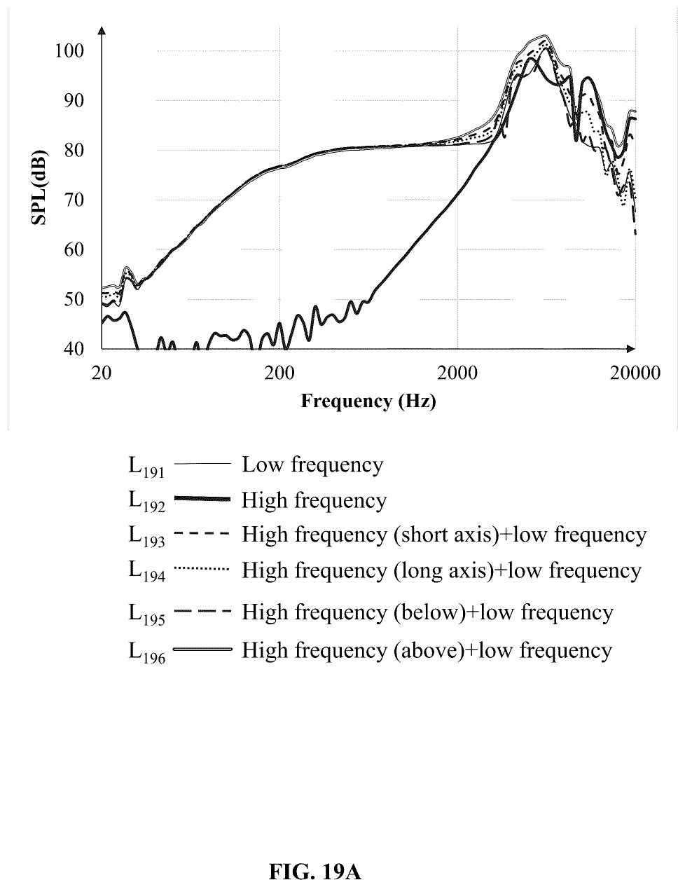

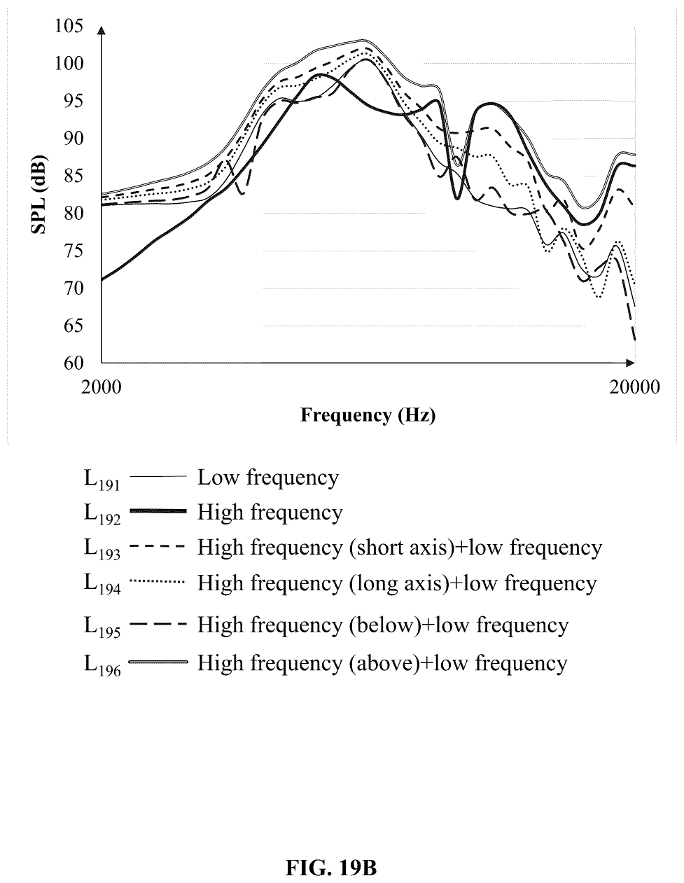

FIG. 18A to FIG. 18D are schematic diagrams of a housing corresponding to different placement positions of a high-frequency acoustic unit according to some embodiments of the present disclosure. FIG. 19A is a schematic diagram of frequency response curves of an acoustic output device corresponding to different placement positions of a high-frequency acoustic unit according to some embodiments of the present disclosure. FIG. 19B is an enlarged view of the mid-to-high frequency curves in FIG. 19A

In some embodiments, the high-frequency acoustic unit 14 may be provided at an end of the housing 11 along the short-axis direction Y. In some embodiments, the high-frequency acoustic unit 14 may be provided on an outer side of the housing 11, such as on the upper side surface US, the lower side surface LS, etc., as shown in FIG. 18A. In some embodiments, the high-frequency acoustic unit 14 may be provided on an inner side of a corresponding sidewall (e.g., the upper side surface US, lower side surface LS, etc.) of the housing 11. The sound guiding hole (e.g., the third sound guiding hole 113) corresponding to the high-frequency acoustic unit 14 may be directly oriented toward the inner side surface IS.

In some embodiments, the high-frequency acoustic unit 14 may be provided at an end of the housing 11 along the long-axis direction X. In some embodiments, the high-frequency acoustic unit 14 may be provided on the outer side of the housing 11. In this case, since one end of the housing 11 along the long-axis direction X is the connection end CE for connecting to the support structure 12, the high-frequency acoustic unit 14 may be provided on the rear side surface RS of the housing 11, as shown in FIG. 18B. In some embodiments, the high-frequency acoustic unit 14 may be provided on an inner side of a corresponding sidewall (e.g., the connection end CE, rear side surface RS, etc.) of the housing 11. The sound guiding hole corresponding to the high-frequency acoustic unit 14 (e.g., the third sound guiding hole 113) may be directly oriented toward the inner side surface IS.

In some embodiments, the high-frequency acoustic unit 14 may be positioned below the low-frequency acoustic unit 13 along the thickness direction Z. That is to say, along the thickness direction Z, the high-frequency acoustic unit 14 is closer to the outer side surface OS relative to the low-frequency acoustic unit 13. In some embodiments, since structures such as a control button, a touch-sensitive zone, etc., may be provided on the outer side surface OS of the housing 11, the high-frequency acoustic unit 14 may be provided inside the housing 11. As the inner side surface IS of the housing 11 is close to the user's ear canal, and the low-frequency acoustic unit 13 is positioned between the high-frequency acoustic unit 14 and the inner side surface IS, a sound guiding tube may be provided within the housing 11 to direct the sound from the high-frequency acoustic unit 14 toward the user's ear canal. One end of the sound guiding tube is acoustically coupled to one side of the diaphragm of the high-frequency acoustic unit 14, and the other end of the sound guiding tube is oriented toward the inner side surface IS, as shown in FIG. 18C.

In some embodiments, the high-frequency acoustic unit 14 may be positioned above the low-frequency acoustic unit 13 along the thickness direction Z. That is to say, along the thickness direction Z, the high-frequency acoustic unit 14 is closer to the inner side surface IS relative to the low-frequency acoustic unit 13. In some embodiments, the high-frequency acoustic unit 14 may be provided on the outer side of the housing 11, i.e., on the inner side surface IS, as shown in FIG. 18D. In some embodiments, the high-frequency acoustic unit 14 may be provided on the inner side of the corresponding sidewall (i.e., the inner side surface IS) of the housing 11. The orientation of the sound guiding hole corresponding to the high-frequency acoustic unit 14 (e.g., the third sound guiding hole 113) may be the same as that of the first sound guiding hole 111.

In some embodiments, when the acoustic output device 10 is worn in the manner shown in FIG. 8, with the rear side surface RS of the housing 11 extending into the cavum concha, the frequency response curves of the acoustic output device 10 corresponding to different placement positions of the high-frequency acoustic unit 14 are as shown in FIG. 19A and FIG. 19B. Referring to FIG. 19A and FIG. 19B, curve L₁₉₁ represents a frequency response curve of the acoustic output device when only the low-frequency acoustic unit 13 is operating. Curve L₁₉₂ represents a frequency response curve of the acoustic output device when only the high-frequency acoustic unit 14 is operating. Curve L₁₉₃ represents a frequency response curve of the acoustic output device when both the low-frequency acoustic unit 13 and the high-frequency acoustic unit 14 corresponding to FIG. 18A are operating simultaneously. Curve L₁₉₄ represents a frequency response curve of the acoustic output device when both the low-frequency acoustic unit 13 and the high-frequency acoustic unit 14 corresponding to FIG. 18B are operating simultaneously. Curve L₁₉₅ represents a frequency response curve of the acoustic output device when both the low-frequency acoustic unit 13 and the high-frequency acoustic unit 14 corresponding to FIG. 18C are operating simultaneously. Curve L₁₉₆ represents a frequency response curve of the acoustic output device when both the low-frequency acoustic unit 13 and the high-frequency acoustic unit 14 corresponding to FIG. 18D are operating simultaneously. As shown in FIG. 19A and FIG. 19B, compared to curve L₁₉₁ without the high-frequency acoustic unit 14, curves L₁₉₃, L₁₉₄, L₁₉₅, and L₁₉₆ with the high-frequency acoustic unit 14 all show improved sensitivity in the high-frequency range (e.g., above 8 kHz). That is to say, providing the high-frequency acoustic unit 14 can effectively enhance the acoustic output performance of the acoustic output device 10 in the high-frequency range. Compared to curves L₁₉₃, L₁₉₄, and L₁₉₅, curve L₁₉₆ exhibits the highest overall sensitivity. In other words, among the four placement positions shown in FIG. 18A to FIG. 18D, the structure where the high-frequency acoustic unit 14 is positioned on the inner side surface IS as shown in FIG. 18D can best improve the acoustic output performance of the acoustic output device 10.

Some embodiments of the present disclosure further provide another acoustic output device, which includes a low-frequency acoustic unit, a high-frequency acoustic unit, a housing, and a support structure. The structure of the low-frequency acoustic unit, the high-frequency acoustic unit, the housing, and the support structure of the acoustic output device, as well as their arrangement, are similar or identical to those of the low-frequency acoustic unit 13, the high-frequency acoustic unit 14, the housing 11, and the support structure 12 of the acoustic output device 10. The difference between this acoustic output device and the acoustic output device 10 lies in that, among the at least two sound guiding holes provided on the housing 11, in addition to including the first sound guiding hole and the second sound guiding hole corresponding to the low-frequency acoustic unit and the third sound guiding hole corresponding to the high-frequency acoustic unit, this acoustic output device may also include another sound guiding hole (e.g., a fourth sound guiding hole) corresponding to the high-frequency acoustic unit. The third sound guiding hole and the fourth sound guiding hole are respectively provided on two sides of the diaphragm of the high-frequency acoustic unit. The high-frequency acoustic unit may radiate sound through the third sound guiding hole and the fourth sound guiding hole separately, and the third sound guiding hole and the fourth sound guiding hole also form a dipole, enhancing the far-field sound leakage reduction of the acoustic output device and improving its acoustic output performance. For more descriptions about this acoustic output device, reference may be made to the relevant descriptions of the aforementioned acoustic output device 10, which will not be repeated here.

Having thus described the basic concepts, it may be rather apparent to those skilled in the art after reading this detailed disclosure that the foregoing detailed disclosure is intended to be presented as illustrative example and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of the present disclosure.

Moreover, certain terminology has been configured to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various portions of this disclosure are not necessarily all referring to the same embodiment. Furthermore, the particular features, structures, or characteristics may be combined as suitable in one or more embodiments of the present disclosure.

Similarly, it should be noted that in the foregoing description of embodiments of the present disclosure, various features are sometimes grouped together in a single embodiment, drawing, or description thereof for the purpose of streamlining the disclosure aiding in the understanding of one or more of the various inventive embodiments. This way of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities or properties configured to describe and claim certain embodiments of the present disclosure are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameter set forth in the written description and attached claims are approximations that may vary depending upon the desired properties sought to be obtained by a particular embodiment. In some embodiments, the numerical parameter should be construed in light of the number of reported significant digits and by applying ordinary rounding techniques. Notwithstanding that the numerical ranges and parameter setting forth the broad scope of some embodiments of the present disclosure are approximations, the numerical values set forth in the specific examples are reported as precisely as practicable.

In closing, it is to be understood that the embodiments of the present disclosure disclosed herein are illustrating of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

1. An acoustic output device, comprising:
a low-frequency acoustic unit;
a high-frequency acoustic unit;
a housing configured to at least accommodate the low-frequency acoustic unit and the high-frequency acoustic unit; and
a support structure configured to place the housing at a position near an ear canal without blocking an ear canal opening of the ear canal, wherein
at least two sound guiding holes are provided on the housing,
a first sound guiding hole and a second sound guiding hole of the at least two sound guiding holes are acoustically coupled to two sides of a diaphragm of the low-frequency acoustic unit, respectively,
the low-frequency acoustic unit radiates sound to an exterior of the housing through the first sound guiding hole and the second sound guiding hole,
one sound guiding hole of the at least two sound guiding holes is acoustically coupled to one side of a diaphragm of the high-frequency acoustic unit,
the high-frequency acoustic unit radiates sound to the exterior of the housing through the one sound guiding hole, and
in a wearing state of the acoustic output device, the one sound guiding hole corresponding to the high-frequency acoustic unit is oriented toward the ear canal of a user.

2. The acoustic output device of claim 1, wherein the one sound guiding hole is a third sound guiding hole;
the high-frequency acoustic unit radiates sound to the exterior of the housing through the third sound guiding hole; and
the first sound guiding hole, the second sound guiding hole, and the third sound guiding hole are provided at different positions on the housing.

3. The acoustic output device of claim 2, wherein the third sound guiding hole is closer to the ear canal of the user than the first sound guiding hole and the second sound guiding hole.

4. The acoustic output device of claim 2, wherein the housing includes an inner side surface opposite to an anterolateral surface of an auricle of the user when the acoustic output device is in the wearing state, and the first sound guiding hole and the third sound guiding hole are located on the inner side surface.

5. The acoustic output device of claim 1, wherein
the housing includes an inner side surface opposite to an anterolateral surface of an auricle of the user when the acoustic output device is in the wearing state,
the one sound guiding hole is the first sound guiding hole,
the first sound guiding hole is acoustically coupled to one side of the diaphragm of the low-frequency acoustic unit and one side of the diaphragm of the high-frequency acoustic unit,
the first sound guiding hole is located on the inner side surface, and
the low-frequency acoustic unit and the high-frequency acoustic unit radiate sound toward the ear canal of the user through the first sound guiding hole.

6. The acoustic output device of claim 4, wherein an overlap ratio between a projection area of the high-frequency acoustic unit on the inner side surface of the housing and a projection area of the first sound guiding hole of the low-frequency acoustic unit on the inner side surface is not greater than 10%.

7. The acoustic output device of claim 4, wherein a centroid of a projection of the high-frequency acoustic unit on the inner side surface of the housing is closer to a junction between the support structure and the housing than a centroid of a projection of the first sound guiding hole of the low-frequency acoustic unit on the inner side surface.

8. The acoustic output device of claim 7, wherein in the wearing state, an end of the housing away from the junction extends into a cavum concha of the user.

9. The acoustic output device of claim 8, wherein
the housing includes a short-axis direction and a long-axis direction, and
in the short-axis direction of the housing, the centroid of the projection of the high-frequency acoustic unit on the inner side surface is closer to an upper side surface of the housing than the centroid of the projection the first sound guiding hole of the low-frequency acoustic unit on the inner side surface.

10. The acoustic output device of claim 4, wherein the high-frequency acoustic unit is located at a lower side surface of the housing or at a junction between the lower side surface and the inner side surface of the housing.

11. The acoustic output device of claim 10, wherein in the wearing state, at least a portion of the housing covers an antihelix region of the user.

12. The acoustic output device of claim 11, wherein an angle between a vibration direction of the high-frequency acoustic unit and a vibration direction of the low-frequency acoustic unit ranges from 36° to 54°.

13. The acoustic output device of claim 4, wherein
the inner side surface of the housing includes a projection region and a non-projection region of the high-frequency acoustic unit, and
in a thickness direction of the housing, the projection region protrudes relative to the non-projection region.

14. The acoustic output device of claim 13, wherein in the thickness direction of the housing, a height difference between the projection region and the non-projection region is not less than 0.6 mm.

15. The acoustic output device of claim 14, wherein in the thickness direction of the housing, a ratio of the height difference between the projection region and the non-projection region to a thickness of the housing is greater than 0.05.

16. The acoustic output device of claim 4, wherein
the inner side surface of the housing includes a projection region and a non-projection region of the high-frequency acoustic unit, and
the projection region is flush with the non-projection region.

17. The acoustic output device of claim 4, wherein
the inner side surface of the housing includes a projection region and a non-projection region of the high-frequency acoustic unit, and
a ratio of a height difference between the projection region and the non-projection region in a thickness direction of the housing to a thickness of the housing is less than 0.3.

18. The acoustic output device of claim 1, wherein
a minimum resonant frequency corresponding to the high-frequency acoustic unit is not lower than 5 kHz, and
a minimum resonant frequency corresponding to the low-frequency acoustic unit is not higher than 1 kHz.

19. An acoustic output device, comprising:
a low-frequency acoustic unit;
a high-frequency acoustic unit;
a housing configured to at least accommodate the low-frequency acoustic unit and the high-frequency acoustic unit; and
a support structure configured to place the housing at a position near an ear canal without blocking an ear canal opening of the ear canal, wherein
at least two sound guiding holes are provided on the housing,
the low-frequency acoustic unit and the high-frequency acoustic unit respectively radiate sound to an exterior of the housing through one or more sound guiding holes of the at least two sound guiding holes,
the housing includes an inner side surface opposite to an anterolateral surface of an auricle of a user when the acoustic output device is in a wearing state,
one sound guiding hole of the at least two sound guiding holes is located on the inner side surface and acoustically connected to the low-frequency acoustic unit,
in the wearing state, a sound guiding hole corresponding to the high-frequency acoustic unit is oriented toward the ear canal of the user, and
an overlap ratio between a projection area of the high-frequency acoustic unit on the inner side surface of the housing and a projection area of the one sound guiding hole corresponding to the low-frequency acoustic unit on the inner side surface is not greater than 10%.

20-36. (canceled)

37. The sound output device of claim 1, wherein a difference between a minimum resonant frequency of the high-frequency acoustic unit and a minimum resonant frequency of the low-frequency acoustic unit is more than or equal to 4 kHz;
or, a ratio of the minimum resonant frequency of the high-frequency acoustic unit to the minimum resonant frequency of the low-frequency acoustic unit is more than or equal to 5.
